(19) United States
(12) Patent Application Publication
(10) Pub. No.: US 2002/0016935 A1
(43) Pub. Date: Feb. 7, 2002

(54) Method and apparatus for scanning records

(76) Inventors: Bjorn Bergsten, Southborough, MA (US); Praveen G. Mutalik, Southborough, MA (US); Hrushikesh Vinayak Bhide, Marlborough, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/961,608

(22) Filed: Sep. 24, 2001

Related U.S. Application Data
(63) Continuation-in-part of application No. 09/833,835, filed on Apr. 12, 2001.
(63) Continuation-in-part of application No. 09/550,108, filed on Apr. 14, 2000.

(51) Int. Cl. G06F 11/00

(52) U.S. Cl. 714/20

(57) ABSTRACT

A method and apparatus for managing one or more records. A scan module transmits a scan request to a session storage manager. The scan request identifies a particular record at which the scan module 612 starts a scan session. The session storage manager also receives an application request from an application to modify the record. The session storage manager then transforms the requested record into a version if the record exhibits a predetermined characteristic.

### CROSS-REFERENCE TO RELATED APPLICATIONS

This application is a continuation-in-part of U.S. patent application Ser. No. 09/833,835, filed Apr. 12, 2001, and U.S. patent application Ser. No. 09/550,108, filed Apr. 14, 2000, the entire disclosures which are incorporated by reference herein.

### FIELD OF THE INVENTION

The present invention relates generally to managing records of information and, more specifically, to coherently and incrementally scanning records of information that are stored sequentially.

### BACKGROUND OF THE INVENTION

A scan session is typically performed to iterate through records of information in a collection of records. Typically, a scan session is performed until stopped or until all of the records have been viewed. A scan session can be initiated for several reasons, such as to support data mining, decision support, and/or statistical processing. A scan session can also be used to replicate the collection of records or a subset of the collection of records. This is often used with session information associated with a communication session between a client computer and a web server.

However, if the web server performs a scan session, such as for mining data accessible to the web server or replicating the data, the efficiency of the web server is often compromised.

Furthermore, a scan session can also be invoked to scan through a collection of records in a database. A database management system (DBMS) provides users and application programs with the ability to retrieve data from a database, such as a relational database.

When more than one transaction is being processed by a DBMS, concurrency problems can arise which may lead to the unreliable execution of the transactions. One technique used to solve concurrency problems is to serially execute the transactions so that only one transaction ever executes on the DBMS at a time. However, if the DBMS can only process a single transaction at a time, the DBMS becomes a bottleneck and transactions may have to wait a significant amount of time before being processed. Serial execution is also an undesirable solution when the transactions are sufficiently unrelated (i.e., do not operate on common data) such that they can execute concurrently and pose no concurrency problems.

Another approach to ensure that transactions encounter a consistent view of the database is to provide a mechanism that allows a reader transaction to encounter a version, or copy, of the data item (e.g., record, file, portion of file) that does not include the updates made by any uncommitted transaction. Further, the versions may be used in a scan session.

However, the versions have typically not been made persistent because all uncommitted transactions will abort if the server experiences a failure. Consequently, a scan may have to restart following a server failure. Additionally, after a server failure, a scan may return different records than in the previous scan session (before the server failure), so the receiving device/process typically has to ignore the records received in the first scan session prior to starting the second scan session. Further, a re-scan of the same database typically causes the scanning of all of the specified records, even the records viewed in a previous scan. This may be costly in terms of processor cycles and completion time.

Thus, there remains a need to efficiently scan records. Additionally, there remains a need to encounter a consistent view of the database following a server failure while not decreasing the performance of the server.

### SUMMARY OF THE INVENTION

The present invention relates to methods and apparatus for managing one or more records. One object of the invention is to enable efficient scanning of records of information. Another object of the invention is to enable a scan session to survive a server failure while not decreasing the performance of the server so that, for instance, statistical and data mining processing can access all of the records.

In one aspect, one feature of the invention is a method to manage one or more records. The method includes the step of receiving a scan request from a scan module. The scan request identifies a record. The method additionally includes the steps of receiving an application request from an application to modify the record and transforming the requested record into a version if the record exhibits a predetermined characteristic.

In one embodiment, the method includes transmitting the version to the scan module. The method can also include copying the record into an update copy if the application request is an update to the requested record and the record exhibits the predetermined characteristic.

In another aspect, the invention is an apparatus for managing one or more records. The apparatus includes a scan module and a session storage manager. The session storage manager is in communication with the scan module and receives a scan request from the scan module that identifies a particular record. The session storage manager also receives an application request to modify the record. The session storage manager transforms the requested record into a version and stores the version in a persistent volatile memory before performing the modification if the record exhibits a predetermined characteristic.

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. Also, the drawings are not necessarily to scale, emphasis instead generally being placed upon illustrating the principles of the invention.

FIG. 1A is a block diagram of an embodiment of a client server system constructed in accordance with the invention.

FIG. 1B is a more detailed block diagram of the client server system shown in FIG. 1A.

FIG. 2 is a block diagram of an embodiment of the server shown in FIG. 1A.

FIG. 3 is a block diagram of an embodiment of a structure of a database, a record cache, and a data structure stored in the server of FIG. 1A.

FIG. 4 is a flowchart illustrating an embodiment of the operation of a session storage manager to log the session information in accordance with the invention.

FIG. 5 is a flowchart illustrating an embodiment of the operation of the session storage manager to recover from a failure of the server in accordance with the invention.

FIG. 6 is a block diagram of an embodiment of the server shown in FIG. 1A having a scan module in accordance with the invention.

FIG. 7 is a block diagram of an embodiment of a structure of a transaction array, a scan array, the records stored in these arrays, and associated parameters of these arrays in accordance with the invention.

FIG. 8A is a flow chart illustrating an embodiment of an updating algorithm performed by the session storage manager in response to a request to update session information.

FIG. 8B is a flow chart illustrating an embodiment of a deleting algorithm performed by the session storage manager in response to a request to delete session information.

FIG. 8C is a flow chart illustrating an embodiment of the operation of the session storage manager to help determine whether to create a version of the session information.

FIG. 8D is a block diagram of an embodiment of the transformations performed on a transaction record shown in FIG. 7 during a scan session in accordance with the invention.

FIG. 8E is a more detailed block diagram of the state of the transaction record of FIG. 7 in accordance with the invention.

FIG. 9 is a flow chart illustrating an embodiment of the operation of the scan module of FIG. 6 to re-scan a database in accordance with the invention.

FIG. 10A is a flow chart illustrating an embodiment of the operation of a function executed by the session storage manager to transmit the next transaction record in the array of transaction records of FIG. 7.

FIG. 10B is a flow chart illustrating a more detailed embodiment of the operation of the function executed by the session storage manager to transmit the next transaction record in the array of transaction records of FIG. 7.

FIG. 10C is a flow chart illustrating an embodiment of the steps performed by the session storage manager to determine whether a transaction record has been or should be transmitted to the scan module during a scan session.

### DETAILED DESCRIPTION OF THE INVENTION

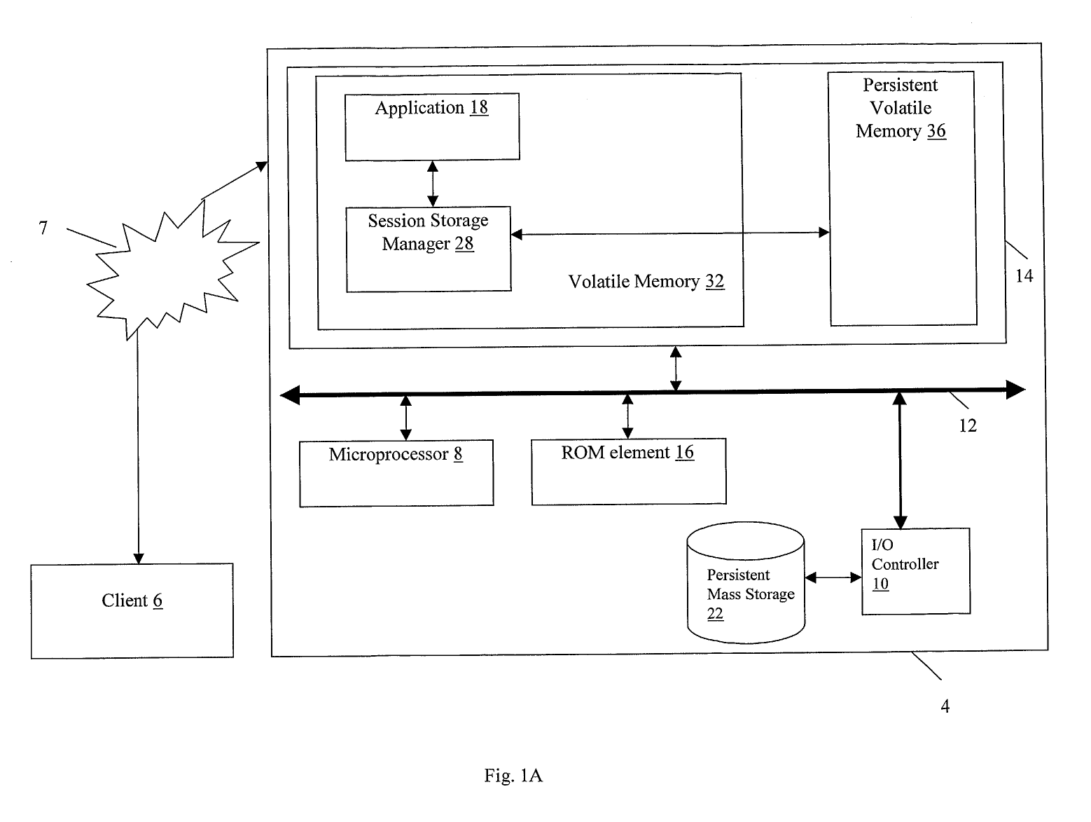

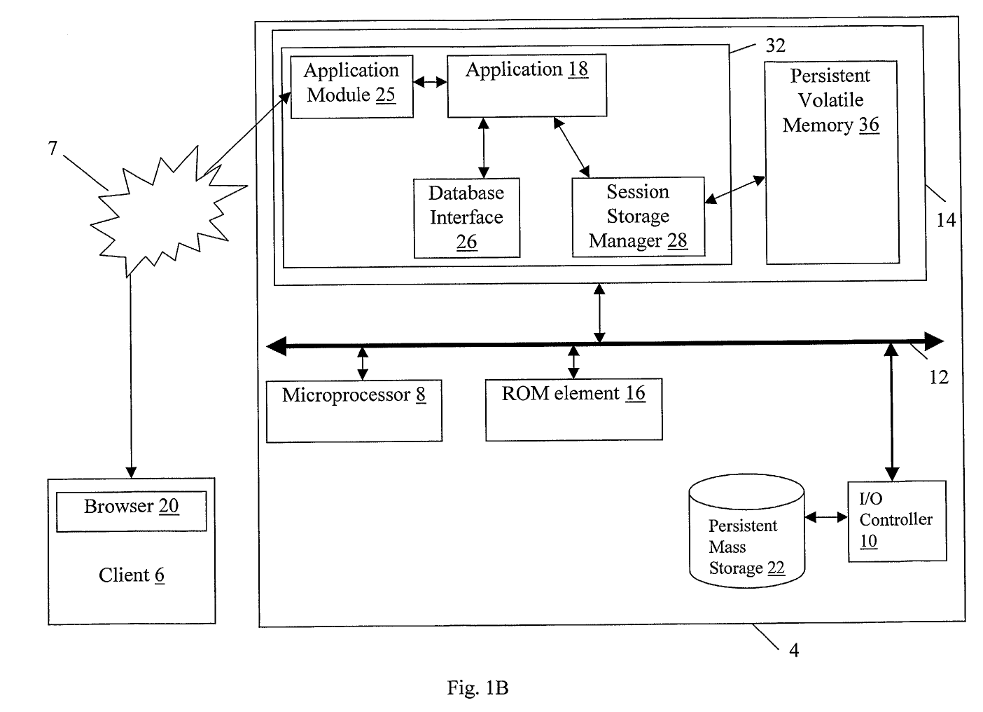

In brief overview and referring to FIG. 1A, a server computer (server) 4 is in communication with a client computer (client) 6, over a network 7. In another embodiment, the client 6 is in direct communication with the server 4, thus eliminating the network 7. In yet another embodiment, multiple clients (not shown) communicate with the server 4 simultaneously. The server 4 includes a microprocessor 8, a read-only memory (ROM) 16, a random access memory (RAM) 14, and a communications bus 12 allowing communication among these components.

The server 4 and/or the client 6 can be any personal computer, WINDOWS-based terminal (developed by Microsoft Corporation of Redmond, Wash.), network computer, wireless device, information appliance, X-device, workstation, mini computer, main frame computer, personal digital assistant, or other computing device.

In the embodiment shown in FIG. 1A, the server 4 uses an input-output (I/O) controller 10 to communicate with a persistent mass storage 22. The persistent mass storage 22 may be any storage medium that retains data in the absence of electrical power, such as a magnetic disk or magneto-optical drive.

The persistent mass storage 22 may be an internal or external component of the server 4. In particular, the server 4 may be provided with redundant arrays of independent disks (RAID arrays) used as failure-tolerant persistent mass storage 22. The server 4 can also be in communication with a peripheral device (not shown), such as a mouse, printer, alphanumeric keyboard, and display.

The RAM memory 14 and the ROM memory 16 may store programs and/or data. The RAM memory 14 may be, without limitation, dynamic RAM (DRAM), static RAM, synchronous DRAM (SDRAM), double data rate synchronous dynamic RAM (DDR SDRAM), and the like. Similarly, the ROM memory 16 may be, without limitation, electrically erasable programmable read-only memory (EEPROM), a programmable read-only memory (PROM), and the like.

The RAM memory 14 typically contains one or more application programs 18 and an operating system (not shown). Examples of the OS include, but are not limited to, Windows 2000 developed by Microsoft Corporation of Redmond, Wash., OS/2 developed by IBM Corporation of Armonk, N.Y., and Netware developed by Novell, Incorporated of San Jose, Calif.

In the embodiment shown in FIG. 1A, the RAM memory 14 is partitioned into volatile memory 32 and persistent volatile memory 36. As described in greater detail in co-pending U.S. patent application Ser. No. 09/550,108, which is incorporated herein by reference, persistent volatile memory 36 is volatile memory whose contents are resistant to loss or corruption from system or application crashes and the ensuing reboot cycle.

In one embodiment, the client 6 sends a user request over the network 7 to the server 4. The server 4 may then establish a communication session with the client 6. As described in more detail below, when the client 6 and the server 4 establish a communication session, such as a TCP/IP session, the client 6 or the server 4 typically stores information about each communication session, referred to as “session information”. For example, session information may include the items that a user places in a “virtual” shopping cart for purchase and/or search queries by the user (e.g., a search query for a particular product). Other session information includes, without limitation, the user's address, phone number, social security number, or birth date.

The volatile memory 32 further includes a storage session manager (SSM) 28. The SSM 28 updates and/or stores session information in the persistent volatile memory 36 without substantially decreasing the performance of the server 4. The SSM 28 initially stores the session information in a cache file (not shown) located in the volatile memory 32 for efficient retrieval of session information. In one embodiment, the SSM 28 transfers the session information from the volatile memory 32 to a database file (not shown) located in the persistent volatile memory 36 or on a disk so that the session information is not lost upon a server failure. In a further embodiment and described in more detail below, the SSM 28 employs two log files as respective backups to the cache file and the database file. Thus, in the event of a failure of the server 4, the SSM 28 can recover the session information from the database file and the log files located in the persistent volatile memory 36.

In more detail and referring to FIG. 1B, the client 6 includes a web browser 20, such as INTERNET EXPLORER developed by Microsoft Corporation in Redmond, Wash., to connect to the network 7.

In one embodiment, the server 4 additionally includes an application module 25 and a database having a database interface 26. In one embodiment, the application module 25 is an Internet Information Server (IIS), developed by Microsoft Corporation of Redmond, Wash. In one embodiment, the application 18 is an “e-commerce” application (an application used to conduct business on the network 7) such as an on-line order taking program.

In operation, the client 6 transmits a user request to the server 4 using, for example, a common gateway interface (CGI) request. The application module 25 passes the received CGI request to the application 18, which can access and update information stored in the database using the database interface 26. The database interface 26 may be an application program interface or a Component Object Model (COM) object. The COM was developed by Microsoft Corporation of Redmond, Wash.

The database (and/or the database interface 26) may be written in a structured query language, such as SQL, developed by IBM Corporation of Armonk, N.Y. In one embodiment, the database interface 26 uses a Lightweight Directory Access Protocol (LDAP) to access information in the database.

In one embodiment, the application 18 instantiates, or creates an instance, of the SSM 28. In a further embodiment, the SSM 28 is a COM object. In one embodiment, the application 18 uses an active server page (ASP), which is a Hypertext Markup Language (HTML) web page that includes one or more scripts (i.e., small embedded programs). In this embodiment, the application 18 invokes one or more scripts to invoke the SSM 28.

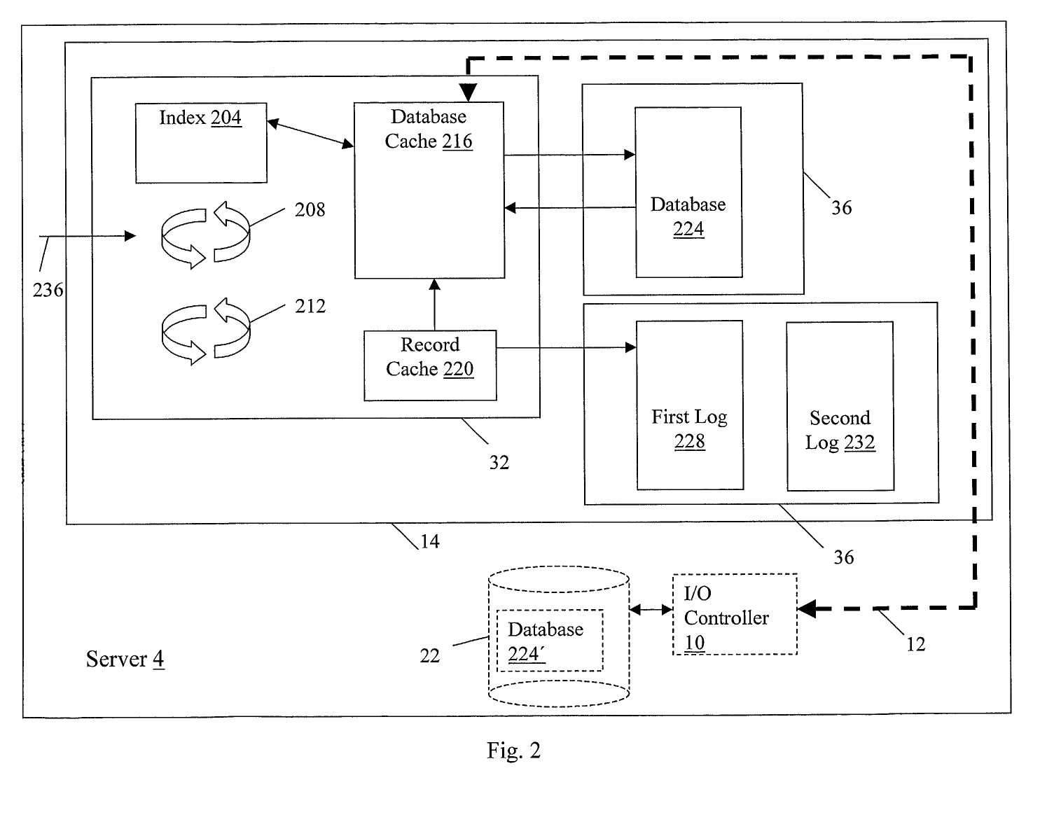

The general architecture of the SSM 28 is illustrated in FIG. 2. The SSM 28 includes an index 204, an execution thread 208, a flushing thread 212, a database cache 216, and a record cache 220 located in a volatile memory 32 of the server 4. The SSM 28 also uses a database 224, a first log file 228, and a second log file 232.

In one embodiment, the database 224 is a file that stores the session information and is located in the persistent volatile memory 36. In another embodiment, a database 224′ (shown in phantom) contains the session information and is located in the persistent mass storage 22.

The database cache 216 is a file located in the volatile memory 32 which stores recently read or written database information. The SSM 28 reads and/or writes session information from/to the database cache 216. The index 204 indexes the database cache 216. In one embodiment, the index 204 uses a unique session information identifier (SID) to enable the SSM 28 to retrieve particular session information from the database cache 216.

The record cache 220 is a region of volatile memory 32 set aside to prevent partial writes to the persistent volatile memory 36. The record cache 220 stores at least one record of session information. Before updating the database cache 216 with session information, the SSM 28 stores the update in the record cache 220. In one embodiment, the record cache 220 specifies the exact location to store the session information in the database 224.

The log files 228, 232 are files that store the session information in the persistent volatile memory 36 before the SSM 28 stores the session information in the database 224. The SSM 28 uses the log files 228, 232 to recreate the session information after a server failure that occurred before transferring all of the session information to the database 224. One of the log files 228, 232 is an “active” log and the other log file 228, 232 is a “passive” log. The active log is a backup for the database cache 216. The SSM 28 uses the passive log file during the recovery process (i.e., after a server failure) to recreate lost session information at the server 4. In particular, the SSM 28 uses the passive log to recreate session information that was not stored in the database 224; this can occur because of a server failure prior to the completion of a transfer of session information from the database cache 216 to the database 224. Thus, in one embodiment the log files 228, 232 provide the SSM 28 with the last piece of session information that the SSM 28 transferred before the server 4 failed. In one embodiment, the log files 228, 232 are located in the persistent volatile memory 36. In another embodiment, either or both the first log 228 and the second log 232 are located in the persistent mass storage 22.

The execution thread 208 is a program, command, or part of a program or command that executes all application requests 236 that the SSM 28 receives from the application 18 (associated with a user request). The flushing thread 212 is a program, command, or part of a program or command that is responsible for flushing the volatile memory 32 (e.g., the database cache 216) to the persistent volatile memory 36 (e.g., the database 224).

In operation, the application 18 transmits the application request 236 to the SSM 28. The SSM 28 generates a record of session information associated with the application request 236 and stores the record in the record cache 220. The SSM 28 then transmits the record of session information from the record cache 220 to the active log. In one embodiment, the SSM 28 transmits the record of session information to the active log with a file “append” operation. The “append” operation is synchronous and, consequently, the SSM 28 waits for the “append” operation to commit the session information to the active log before continuing execution.

If a failure of the server 4 occurs prior to the completion of the transmission of the session information to the active log, the contents of the record cache 220 are lost and are typically irretrievable. As stated above, the SSM 28 uses the log files 228, 232 as a backup for the database 224. Since the SSM 28 stores no updates to the session information in the database cache 221 prior to transmitting the session information to the active log, then no updates have been written to the database 224. In one embodiment, the server 4 transmits an error to the client 6 stating that the update to the session information was not stored. Upon recovery, the SSM 28 will determine that the session information was not stored in the log file 228, 232 and discard the portion of the update that was transmitted to the active log. The user of the server 4 may transmit the update to the session information again following recovery of the server 4.

In one embodiment, the SSM 28 employs the log files 228, 232 in an alternate manner. That is, the SSM 28 identifies one of the log files 228, 232 as the active log and the other log file 228, 232 as the passive log. Upon a triggering event, such as after a predetermined amount of time elapses or once a log file 228, 232 stores a predetermined amount of session information, the SSM 28 switches the identities of the log files 228, 232. Thus, the SSM 28 identifies the previously identified active log as a passive log and the previously identified passive log as an active log. It should be noted that the SSM 28 does not transfer the session information from one log 228, 232 to the other log 228, 232.

Once the record cache 220 completes its transmission of the record of session information to the active log, the record cache 220 then transmits the session information to the database cache 216. In one embodiment, the SSM 28 transmits the session information to the database cache 216 so that the SSM 28 has access to the session information using the volatile memory 32 (and therefore does not have to access the persistent volatile memory 36). Because the SSM 28 has already implemented a backup of the session information stored in the record cache 220 by updating the active log (before updating the database cache 216), the SSM 28 can transfer the session information to the database cache 216 without risk of losing the session information upon a failure of the server 4.

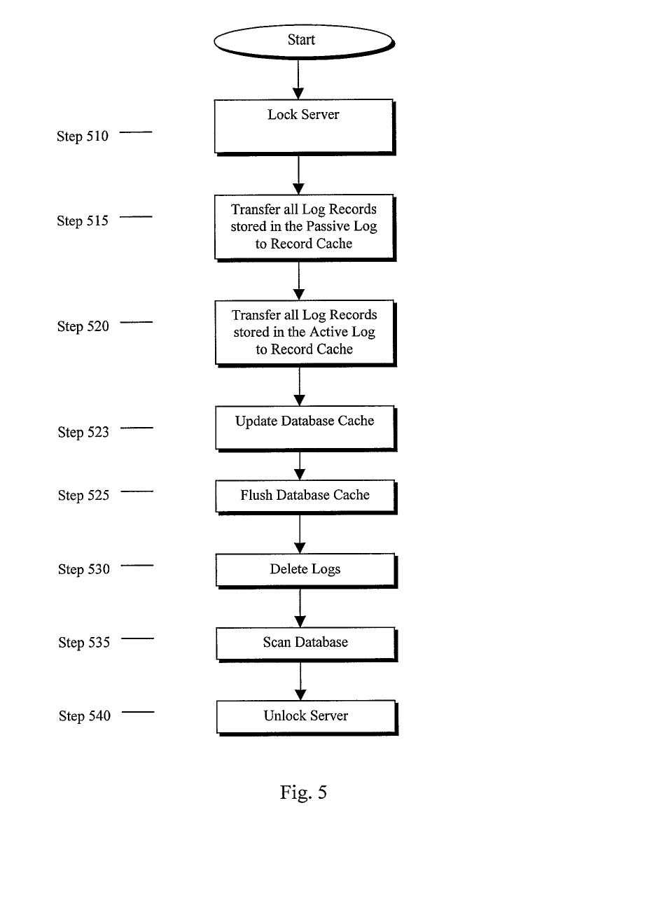

As illustrated in more detail below with respect to FIG. 5, upon a failure of the server 4 during the transmission of the session information to the database cache 216, the SSM 28 recreates the database cache 216 from the database file 224 and the log files 228, 232.

The SSM 28 then stores the session information in the database cache 216 before storing the session information in the database 224. Additionally, the SSM 28 can efficiently retrieve the session information from the volatile memory 32 (e.g., database cache 216) without having to access the persistent volatile memory 36 until the server 4 experiences a failure. In one embodiment, the operating system (not shown) flushes the database cache 216 to the database 224 at predetermined times.

In one embodiment, when the SSM 28 writes to the database cache 216, the operating system identifies that area of memory, or page of memory, as “dirty.” A “dirty” page of memory is a page that is written to prior to transfer to the database 224. Once the operating system identifies the page in the database cache 216 as “dirty”, the operating system asynchronously transmits all “dirty” memory pages to the database 224. Once a page is transmitted, the operating system marks the memory page as “clean.” Thus, the operating system determines which memory pages are modified and consequently need to be transferred to the database 224.

When the operating system performs the asynchronous transfers illustrated above, the SSM 28 still accepts application requests 236 while the operating system updates the database 224. As described in more detail below, the updates done after the operating system has started the transfer are written to one of the two log files 228, 232 so that the log file 228, 232 previously written to can be deleted when the transfer is completed.

In another embodiment and as illustrated herein, the flushing thread 212 invokes an operating system command (i.e., a “flush” function) to transfer the session information from the database cache 216 to the database 224. In one embodiment, the flushing thread 212 asynchronously performs the transfer, as described above. In another embodiment, the flushing thread 212 synchronously performs the transfer, thus waiting for the current flush routine to complete before executing another flush routine. This synchronous transfer guarantees that all updates described in the database cache 216 are written to the database 224.

In greater detail, the application 18 transmits an application request 236 relating to session information to the SSM 28. The application request 236 is associated with the user request that the server 4 receives from the client 6. In one embodiment, the application request 236 interfaces with the SSM 28 via SSM commands. Examples of SSM commands include, without limitation, an SSM_Create command, an SSM_Get command, and an SSM_Put command.

The SSM_Create command creates a new session and returns a unique SID. If there is not enough memory available to generate new session information, the SSM 28 outputs an error message. The SSM_Get command returns the session information associated with the requested SID. For example, the SSM_Get command returns the session information as a binary large object (BLOB) (i.e., a collection of binary data stored as a single entity in a database management system). In another embodiment, the SSM_Get command returns the session information as a document, such as an Extensible Markup Language (XML) document. In another embodiment, the SSM_Get command returns the session information as a text document. The SSM_Put command replaces the record of the current session information associated with the SID with a record of updated session information. In a further embodiment, the SSM_Put command locates the particular byte or bytes that are being updated and only alters these bytes. In yet another embodiment, the application request 236 invokes a SSM_Delete command to delete the session information when that particular session information no longer has a value (e.g., when the server 4 no longer needs the session information because the communication session has ended). Although several embodiments of the application request 236 are presented above, the server 4 may also recognize additional requests 236.

As described above, the execution thread 208 executes the application request 236. In one embodiment, the execution thread 208 processes each SSM command as a transaction.

When the server 4 receives multiple user requests from the client 6 so that the application 18 transmits multiple application requests 236 to the SSM 28, the execution thread 208 executes each application request 236 (i.e., each SSM command) in a serial fashion. That is, the execution thread 208 executes the multiple application requests 236 one at a time and in the order that the SSM 28 receives each application request 236.

Upon the reception of an application request 236 to generate new session information (e.g., for a user who has not previously established a communication session with the server 4), the SSM 28 (i.e., the SSM_Create command) generates a record of session information in the record cache 220. As described in more detail below, the SSM 28 additionally uses the record cache 220 to update the cache entries in the database cache 216 by executing each update to the session information that the record describes. Eventually, the flushing thread 212 transfers the session information that the database cache 216 stores into the database 224 located in the persistent volatile memory 36. The flushing thread 212 executes the transfer in concurrence with the execution of the execution thread 208. In another embodiment, the flushing thread 212 transfers the session information from the database cache 216 to the database 224′ located in the persistent mass storage 22.

The SSM 28 appends the record cache 220 to the active log before the SSM 28 uses the contents of the record cache 220 to update the database cache 216. If the flushing thread 212 writes only a portion of the session information to the database 224 because of a server failure, the SSM 28 completes during the recovery process (described further below in FIG. 5) the operation interrupted by the server failure by reading a copy of the record cache 220 from one of the log files 228, 231.

As an example of the invention with the record cache 220, if the application request 236 updates byte 5 and byte 25 of the session information, the SSM 28 generates a record for the two updates in the record cache 220. The SSM 28 then appends the record for the updates in the active log. The SSM 28 then performs these updates to the session information stored in the database cache 216. More specifically, the SSM 28 updates byte 5 and byte 25 of the session information stored in the database cache 216. The record cache 220 acts as an intermediary between the log files 228, 232 and the database cache 216. In another embodiment, the SSM 28 does not have a record cache 220 and writes the updates directly to the log file 228, 232 and then to the database cache 216.

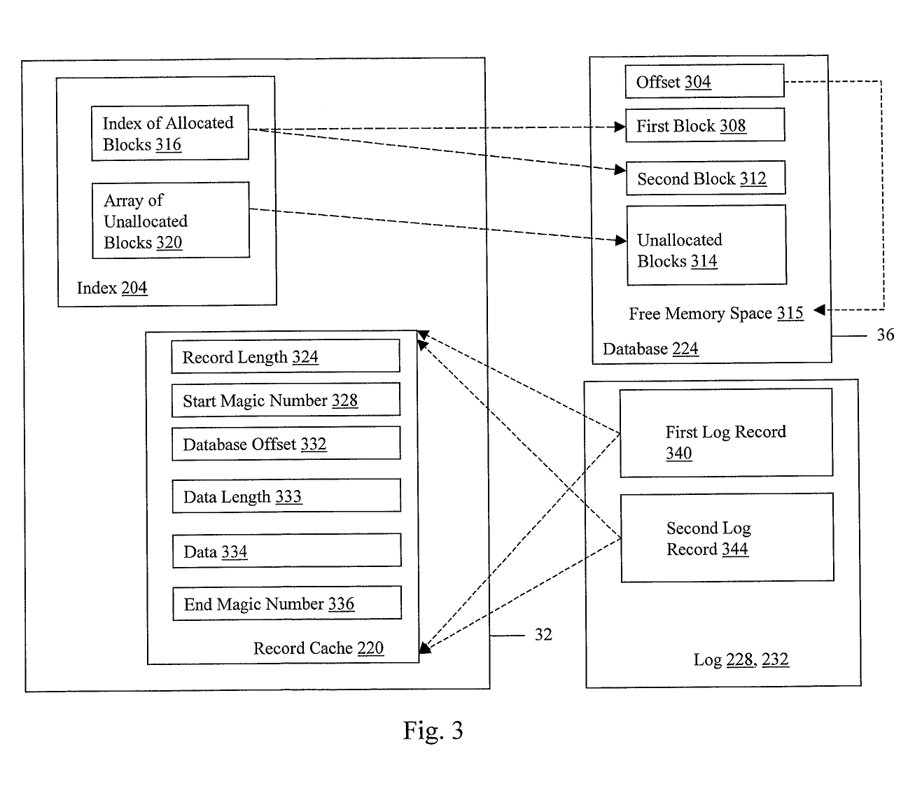

In one embodiment and also referring to FIG. 3, the database 224 (and the database cache 216) includes an offset 304 to linear free memory space 315 in the database 224. The database 224 is also composed of a list of consecutive allocated blocks 308, 312 and unallocated blocks 314. In particular, an allocated block (e.g., first block 308, second block 312) can contain “active” session information, which, in one embodiment, is session information that a request 236 has accessed within a predetermined amount of time. An unallocated block (e.g., unallocated blocks 314) is available to store session information. For example, an unallocated block (e.g., unallocated block 314) can be a memory block in the database 224 that had stored previously active session information which is no longer needed by the SSM 28. The free memory space 315 has never been touched by the SSM 28 and is used by the SSM 28 when no more unallocated blocks 314 exist.

In one embodiment, the SSM 28 associates an allocated block 308, 312 or an unallocated block 314 with an index 204 (e.g., record, list, linked list). Each block 308, 312, 314 may contain, without limitation, information on the type of block 308, 312, 314 (e.g., unallocated, allocated), the size of the block 308, 312, 314 (e.g., 128 bytes), the session information identifier (SID), the size of the session information stored in the block 304, 308, 312, and/or the session information.

In further embodiments, the SSM 28 maintains an index 316 of the allocated blocks 308, 312 for efficient retrieval of the session information stored in the allocated blocks 308, 312. In another embodiment, the SSM 28 additionally maintains an array 320 of the unallocated blocks 314 to manage the unallocated memory space available in the database 224.

Prior to storing a log record (e.g., a first log record 340, a second log record 344) containing session information in a log file 228, 232, in one embodiment the SSM 28 (e.g., SSM_Create command) generates a record of session information and stores the record in the record cache 220. In more detail and in the embodiment shown in FIG. 3, the record cache 220 and the log files 228, 232 include a record length 324, a start magic number 328, a database offset 332, a data length 333, data 334, and an end magic number 336. In one embodiment, the record length 324 is the length of the record of session information (e.g., the length of the first log record 340, the length of the second log record 344). The SSM 28 reads the record length 324 after a server failure so that the SSM 28 can read the rest of the log record 340, 344 at once. It should be noted that the information that the SSM 28 stores after the start magic number 328 (i.e., database offset 332, data length 333, data 334) can be repeated multiple times in the record cache 220 prior to the end magic number 336.

The magic numbers 328, 336 are numbers that the SSM 28 uses to verify the validity of the contents of the intermediate bytes of the respective log record (e.g., the first log record 340, the second log record 344) which are the database offset 332, the data length 333, and the data 334 (i.e., every bit after the start magic number 328 and before the end magic number 336).

In one embodiment, the magic numbers 328, 336 are identical random numbers (i.e., one random number generated for both magic numbers 328, 336) and the SSM 28 determines that the intermediate bytes of the log files 228, 232 have not been modified when the start magic number 328 is equivalent to the end magic number 336. In another embodiment, the magic numbers 328, 336 are predefined numbers. In yet another embodiment, different random number generators each create one of the magic numbers 328, 336. The SSM 28 determines the two random numbers that the random number generators select and determines that the intermediate bytes of the record cache 220 have not been modified when the start magic number 328 and the end magic number 336 are equivalent to the expected values. In other embodiments, the magic numbers 328, 336 are checksums. In yet another embodiment, the magic numbers 328, 336 are cyclic redundancy check (CRC) codes. It should be noted that the start magic number 328 and the end magic number 336 can be any values as long as the SSM 28 can determine whether the intermediate bytes in the log files 228, 232 have been modified.

As an example of the use of the magic numbers 328, 336, if a failure of the server 4 occurs in the middle of an “append” to log file operation described above, then the record cache 220 does not complete the transfer of every byte included in the record of session information stored in the record cache 220 to the log record 340, 344.

As part of the recovery process described below, the SSM 28 reads the record length 324, which contains the size of the log record 340, 344 stored in the log file 228, 232. If the SSM 28 determines that the size of the log file 228, 232 is less than the expected size that the SSM 28 read from the record length 324, then the SSM 28 determines that the failure of the server 4 occurred during the transmission of the session information from the record cache to the active log. The SSM 28 can discard that record of session information because that session information had not been stored in the database 224.

If the SSM 28 determines that the size of the active log is equivalent to the expected size, the SSM 28 verifies that the start magic number 328 is equivalent to the end magic number 336. In one embodiment, if the two magic numbers 328, 336 are equivalent, then the intermediate bytes are not corrupted.

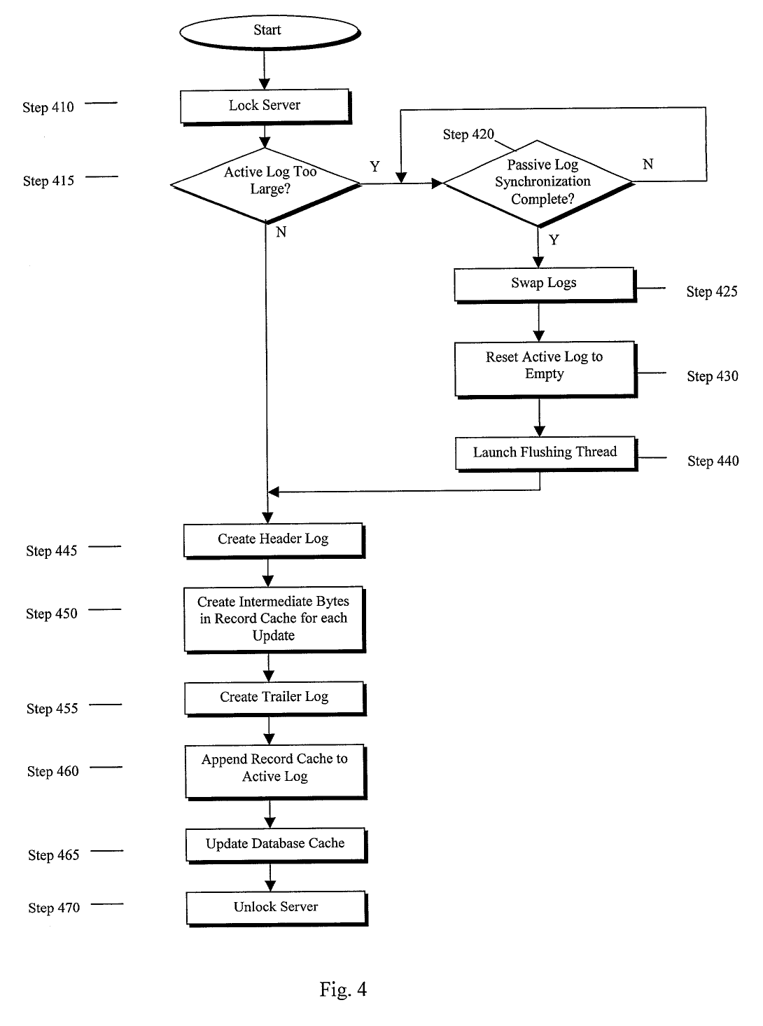

Referring again also to FIG. 1B, to enable the session information to survive a server failure, the server 4 stores the session information in persistent volatile memory 36. For example and also referring to FIG. 4, a user employs the client 6 and sends a user request to the server 4 to purchase an item. Assuming that the user has already established a communication session with the server 4, the server 4 has already generated session information for the particular user. Therefore, the server 4 has to update the session information associated with the particular user. In one embodiment, the user request includes the SID to identify the session information that will be updated.

In response to the user request, the application 18 instantiates the SSM 28 and makes an application request 236 to the SSM 28 to update the session information for the user. In one embodiment, the application request 236 invokes the SSM_Put command to update the session information. Further, the application request 236 (and consequently the SSM_Put command) includes the SID for identification of the session information.

In a typical computer system having a database, a transaction typically “locks” a record of a database before accessing the contents of the record. That is, the record is made inaccessible to other applications. In other embodiments, other applications can read the record but cannot write to the record until the execution of the transaction is complete.

An application may take a long time to complete a transaction. This long completion time can be a result of accessing a record that is stored on a disk or as a result of multiple database accesses, (e.g., as called for by the transaction). In both examples, the computer system (i.e., the processor of the computer system) has to either perform I/O (e.g., to access the record on the disk) or networking (e.g., if the typical computer system accesses the disk and/or the database over a network). For example, the computer system accesses a disk using an I/O controller similar to the I/O controller 10 described above. The I/0 processing and/or the network processing adds further delays to the completion of the transaction.

Further I/O delays may arise due to a “database commit”, which is the final step in the successful completion of a transaction (e.g., an SSM command). For example, all of the steps of a single transaction must be completed before the transaction is deemed successful and the database file is actually changed to reflect the transaction. When a transaction completes successfully, the changes to the file are said to be “committed.”

Rather than locking a particular record, as a typical computer may do when accessing a record in the database, the SSM 28 (i.e., the SSM command) locks (step 410) the server 4 and thereby prevents access to the server until the session is complete. If the transaction accessing the database of the typical computer system described above locks the database (and not just a record stored in the database), other transactions are not able to access the components of the computer system (e.g., the microprocessor, the disk) while the microprocessor waits for the completion of the I/O or networking activity; this results in wasted resources and down-time of the computer system.

In the server 4 of FIG. 1A and FIG. 1B, all session information that the SSM 28 needs to execute the SSM command is located in the RAM memory 14. In particular, and as shown in FIG. 2, the database cache 216 is located in the volatile memory 32 and, consequently, the microprocessor 8 does not have to process any I/O (e.g., disk access) to execute an SSM command and thus access session information. Therefore, the SSM 28 experiences no delay due to I/O processing when accessing the session information. Moreover, the database 224 is located in the persistent volatile memory 36. Thus, the SSM 28 commits the session information to the database 224 located in the persistent volatile memory 36, thereby eliminating the I/O delay from a commit to a database located on a disk, as described above. Furthermore, each SSM command only reads and/or writes session information in the memory 32, 36. Therefore, the microprocessor 8 does not have to perform network processing because of the nature of the transactions.

Further, unlike the routine locking of a record, the SSM 28 locks the server 4 in step 410 to decrease the time spent in locking each record and to increase the speed at which the SSM 28 can access a record because the locking of the server 4 eliminates the overhead of locking each record (as well as the overhead of locking the index 204). Thus, the locking of the server 4 enables the SSM 28 to operate more efficiently and with less complexity. By eliminating network processing and I/O processing for transactions associated with the SSM 28, the SSM commands do not waste resources of the server 4 (e.g., microprocessor 8) despite the locking of the server 4.

For example, the SSM command associated with a user (and therefore an execution thread 208 associated with a user) possesses a token, which is a particular bit or series of bits that enable the execution thread 208 to update the record cache 220. With the correct token, the SSM command (i.e., the execution thread 208) locks the server 4 upon receipt of the application request 236. Thus, in one embodiment, if a second execution thread 208 attempts to update the record cache 220 with a second set of updates while a first execution thread 208 is updating the record cache 220 with a first set of updates, the second execution thread 208 will not be able to update the record cache 220 because the second execution thread 208 (associated with the second SSM command) will not have valid permission to do so.

The SSM 28 then determines (step 415) if the active log is above a predefined size. If the active log is above the predefined size, the SSM 28 determines (step 420) if the passive log and the database 224 are “synchronized.” That is, the SSM 28 determines if all of the contents of the passive log have been reflected in the database 224 (i.e., the execution thread 208 has transmitted all of the updates that are stored in the passive log to the database cache 216 and the flushing thread 228 has subsequently transferred these updates from the database cache 216 to the database 224). In another embodiment, the SSM 28 determines in step 420 if the synchronization between the passive log and the database 224 is complete after a predetermined amount of time.

If the synchronization is not complete, the SSM 28 waits until the contents of the passive log are reflected in the database 224. When the database 224 includes the contents of the passive log, the SSM 28 swaps (step 425) the active log and the passive log and then resets (step 430) the newly named active log to an unallocated, or empty, state. In one embodiment, the SSM 28 resets the newly named active log to an unallocated state because the contents of that log were just transferred to the passive log.

In another embodiment, the predefined size of the active log is adjusted so that the flushing thread 212 completes before the active log reaches the predefined size. In this scenario, the SSM 28 can skip step 420 and consequently swap the logs 228, 232 following the determination that the active log has reached the predefined size.

Once the active log is reset to an unallocated state, new updates to the session information for the particular user may occur and the SSM 28 stores these updates in the active log (i.e., the previously named passive log) and then in the database cache 216. Therefore, to transfer the updates from the database cache 216 to the database 224, the SSM 28 launches (step 440) the flushing thread 212.

If the SSM 28 determines in step 415 that the size of the active log has not reached the predefined size or if the SSM 28 launches the flushing thread 212 in step 440, the SSM 28 creates (step 445) a header log. In one embodiment, the header log includes the record length 324 and the start magic number 328.

The SSM 28 (i.e., the SSM command) then creates (step 450) the intermediate bytes (i.e., the database offset 332, the data length 333, and the data 334) in the record cache 220 for each update to the session information relating to the application request 236 (e.g., relating to the item that the user requests to purchase). The SSM 28 then creates (step 455) a trailer log, which in one embodiment includes the end magic number 336 of the record cache 220, and updates the record length 324.

The execution thread 208 then appends (step 460) the record cache 220 to the active log so that the updated session information is stored in the persistent volatile memory 36. Following the transfer of the session information to the active log, the execution thread 208 updates (step 465) the database cache 216 with the updates stored in the record cache 220. In one embodiment, the transfer of this session information to the database 224 is done asynchronously by the flushing thread 412 in step 440. The SSM 28 then unlocks (step 470) the server.

To recover the session information following a server failure and also referring to FIG. 5, the SSM 28 “locks” (step 510) the server 4, as described above with respect to FIG. 4, to execute the recovery process. In one embodiment, the SSM 28 determines whether the SSM command has valid permission to access the database 224 before locking the server 4. Further, the SSM 28 needs to recreate the session information that was previously stored in the database cache 216. Moreover, the SSM 28 needs to ensure that the database 224 contains all of the session information that was previously stored in the log files 228, 232 (e.g., the session information that was written to the database cache 216 for transfer to the database 224 prior to the server failure and also prior to the completion of the flushing thread 212 transferring the updates to the database 224). Therefore, the execution thread 208 transfers (step 515) all records in the passive log to the record cache 220 and then transfers (step 520) all records in the active log to the record cache 220 (i.e., transfers the records 340, 344 in the log files 228, 232 in the same order that the SSM 28 had generated the records 340, 344 in the log files 228, 232). From there, the execution thread 208 performs (step 523) the updates described in the record cache 220 into the database cache 216, as described above in step 465.

To update the database 224 with the session information that had not been transferred to the database 224 prior to the server failure, the SSM 28 invokes the flushing thread 212 and flushes (step 525) the contents of the database cache 216 to the database 224. Once this completes (and therefore once all of the session information is stored in the database 224), the SSM 28 deletes (step 530) the log files 228, 232 because the session information stored in the log files 228, 232, has just been transferred to the database 224. The SSM 28 then scans (step 535) the database 224 to recreate the information stored in the index 204 (e.g., index 316 of allocated blocks, array 320 of unallocated blocks). Once the SSM 28 restores the session information, the SSM 28 unlocks (step 540) the server 4.

In an environment with multiple clients, the server 4 can also use the invention to conduct a statistical analysis on all session information to determine the behavior of the multiple clients and to observe trends in the marketplace. In particular, the application request 236 can be a request to scan all session information for statistical purposes. In a further embodiment, the scan determines if any session information has been modified after a predetermined time.

In one embodiment, a scan module can scan the records of session information stored by the SSM 28 in the persistent volatile memory 36. In the context of session information management, a scan can be used to replicate the set, or collection, of all records into another system, such as a database system. The scanning of records can also be used, for example, for decision support, data mining, and statistical analysis of the session information. Data mining is a process to identify commercially useful patterns, trends, or relationships in databases or other computer repositories. For example, data mining software can help retail companies find customers with common interests. In one embodiment, the scan module scans the records stored by the SSM 28 into a database (e.g., for statistical analysis, data mining, and/or replication). In a further embodiment, a software module performs the data mining and/or statistical analysis on the records of session information scanned into the database. Although described throughout the specification as session information, the scan module can scan any records containing any information.

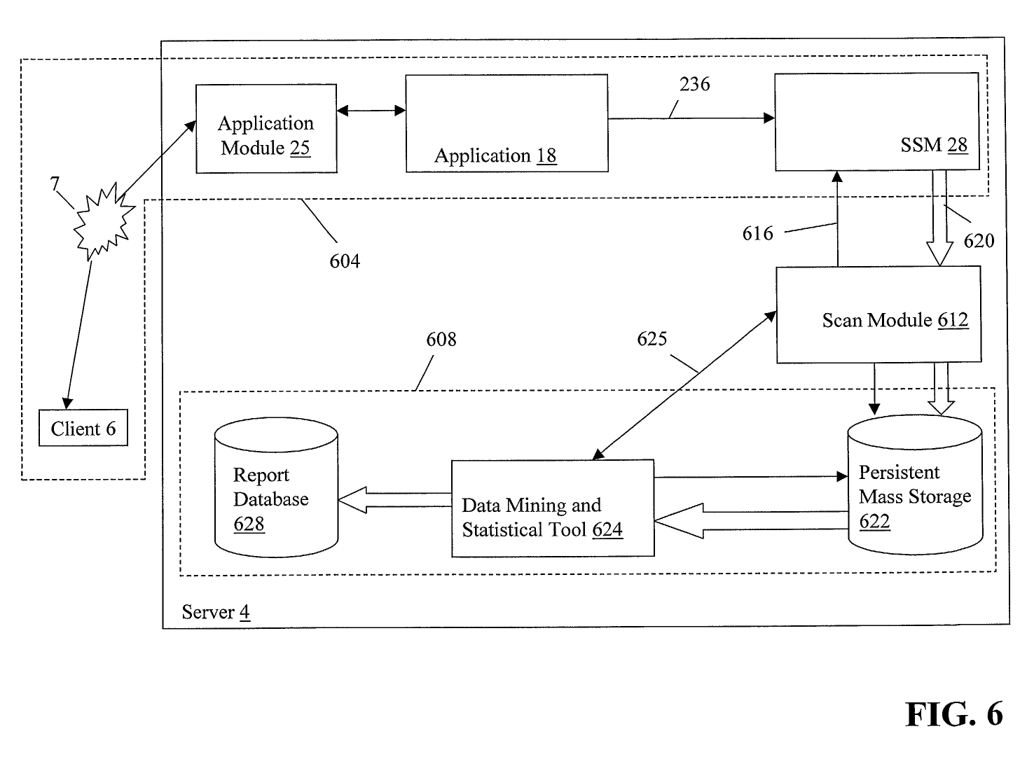

More specifically and referring to FIG. 6, the server 4 includes a production system 604, a decision support system 608, and a scan module 612. The production system 604 includes the client 6, the network 7, the application module 25, the application, 18, and the SSM 28, all of which are described above.

In one embodiment, the scan module 612 is a process executing on the server 4 and in communication with the SSM 28. In another embodiment, the scan module 612 is an external module in communication with the SSM 28, such as a process executing on another server 4 in a server farm (not shown). In yet another embodiment, the scan module 612 executes on a mobile device and communicates with the SSM 28 via the internet. For instance, the scan module 612 can be a mobile telephone, such as a Nokia series 7100 mobile phone developed by Nokia Corporation of Helsinki, Finland. Alternatively, the scan module 612 can be a handheld computer, such as the PALM series, developed by Palm, Inc. of Santa Clara, Calif.

In general, the scan module 612 scans records from one storage device to another storage device. In one embodiment, the scan module 612 scans the records of session information stored by the SSM 28 in the persistent volatile memory 36 into a database. In another embodiment, the scan module 612 scans the records of session information located in a persistent memory, such as a file stored on a disk. In one embodiment, the purpose of a scan is to efficiently mine the data stored in the records. Alternatively, the scan module 612 scans the records solely for replication purposes.

In one embodiment, the scan module 612 initiates and continues a scan session by transmitting scan requests 616 to the SSM 28. The scan module 612 begins the scan session by transmitting a start scan request 616 to the SSM 28. This request typically references the first record of session information that the scan module 612 requests to retrieve from the SSM 28. To retrieve the first record, the scan module 612 transmits a record retrieve request 616. The record retrieve request 616 causes the SSM 28 to execute a next function, also referred to hereinafter as a NextScan function. In one embodiment and as described further below, the record retrieve request 616 includes a record retrieve request identifier to identify the particular record retrieve request 616 associated with the requested record of scan information. The record retrieve request identifier can be, for instance, an incremented predetermined integer or a random number. The server 4 (i.e., the SSM 28) then transmits the requested record 620 to the scan module 612.

After receiving the transmitted record 620, the scan module 612 may transmit another record retrieve request 616 to the SSM 28 to retrieve another record of session information. In one embodiment, the scan module 612 terminates the scan session by transmitting a termination command. Alternatively, the scan module 612 terminates the scan session when the SSM 28 transmits the final record in the collection of records stored in the persistent volatile memory 36 (or persistent memory) to the scan module 612.

The decision support system 608 typically processes complex queries related to the scanned records of session information. The decision support system 608 includes a persistent mass storage 622, a data mining and statistical tool 624, and a report database 628. Although illustrated as separate components, one or more of the components of the decision support system 608 can be combined into one or more modules.

The scan module 612 uses the persistent mass storage 622 to store records received from a scan session. Although described below as a database 622, the persistent mass storage 622 may be any storage medium that retains data in the absence of electrical power, such as a magnetic disk or magneto-optical drive. Further, the persistent mass storage 622 can be internal to or external to the server 4.

The data mining and statistical tool 624 is in communication with the persistent mass storage 622 and the report database 628. The data mining and statistical tool 624 can be software, hardware, or a combination of the two. In one embodiment, the data mining and statistical tool 624 includes algorithms to mine the data that the scan module 612 scanned into the persistent mass storage 622. The description below is a general introduction to the area of data analysis and data mining and serves as an introduction to some of the possible functions and techniques that the data mining and statistical tool 624 may employ.

In one embodiment, the data mining and statistical tool 624 performs data analysis on the records stored in the persistent mass storage 622. The data mining and statistical tool 624 performs cluster analysis by clustering, or grouping, data sets stored on the persistent mass storage 622 on the basis of similarity criteria for appropriately scaled variables that represent the data of interest. In another embodiment, the data mining and statistical tool 624 performs regression analysis, which is the use of statistical methods to characterize the manner in which one variable changes as the other variable changes. In yet another embodiment, the data mining and statistical tool 624 performs pattern recognition analysis, which is the identification of patterns in data sets using appropriate mathematical methodologies. In other embodiments, the data mining and statistical tool 624 analyzes data matrices using regression and/or pattern recognition techniques and therefore performs multivariate statistics.

There are also various kinds of algorithms, or models, that the data mining and statistical tool 624 can use to mine the data stored in the persistent mass storage 622. Examples of data mining models include predictive data mining, descriptive data mining, affinity based data mining, comparative data mining, text mining, time delay data mining, and trends-based data mining. Predictive data mining combines pattern matching, influence relationships, time set correlations, and dissimilarity analysis to offer simulations of future data sets.

Predictive data mining can be used to forecast explicit values, based on patterns determined from known results. For example, from a database of customers who have already responded to a particular offer, a model can be built that predicts which prospects are likeliest to respond to the same offer. Descriptive models describe patterns in existing data, and are generally used to create meaningful subgroups such as demographic clusters.

An affinity based data mining model analyzes (typically large and complex) data sets across multiple dimensions, and the data mining and statistical tool 624 identifies data points or sets that tend to be grouped together. Using this model, the data mining and statistical tool 624 can provide hierarchies of associations and show any underlying logical conditions or rules that account for the specific groupings of data.

Comparative data mining focuses on overlaying (typically large and complex) data sets that are similar to each other. The emphasis in this type of data mining is on finding dissimilarities rather than similarities. In another embodiment, the data mining and statistical tool 624 uses text mining and mines unstructured data, such as literature. In yet another embodiment, the data mining and statistical tool 624 employs time delay data mining and collects the data over time. In a further embodiment, the data mining and statistical tool 624 looks for patterns that are confirmed or rejected as the data set increases and becomes more robust. Trends-based data mining analyzes (typically large and complex) data sets in terms of any changes that occur in specific data sets over time. A user of the data mining and statistical tool 624 could define the data sets or the data mining and statistical tool 624 could uncover them. Examples of the data mining and statistical tool 624 include, without limitation, AnswerTree/Base developed by SPSS of Chicago Ill. and MineSet developed by Silicon Graphics, Inc. of Mountain View, Calif. In one embodiment, the data mining and statistical tool 624 is also in communication with the scan module 612 (as shown with arrow 625) so that the scan module 612 can transmit the scanned records of session information directly to the data mining and statistical tool 624.

Additionally, in one embodiment the data mining and statistical tool 624 has a visualization tool. A visualization tool can be either software, hardware, or any combination of the two that makes the mined data more accessible and interactive. Graphical tools to aid in visualization of the mined data include maps, trees, browsers, 3D viewers, and sequence searching filters.

In one embodiment, the data mining and statistical tool 624 communicates with the report database 628 (using a database interface, such as OLE DB developed by Microsoft Corporation of Redmond, Wash.) for visualization of the data analysis/mining.

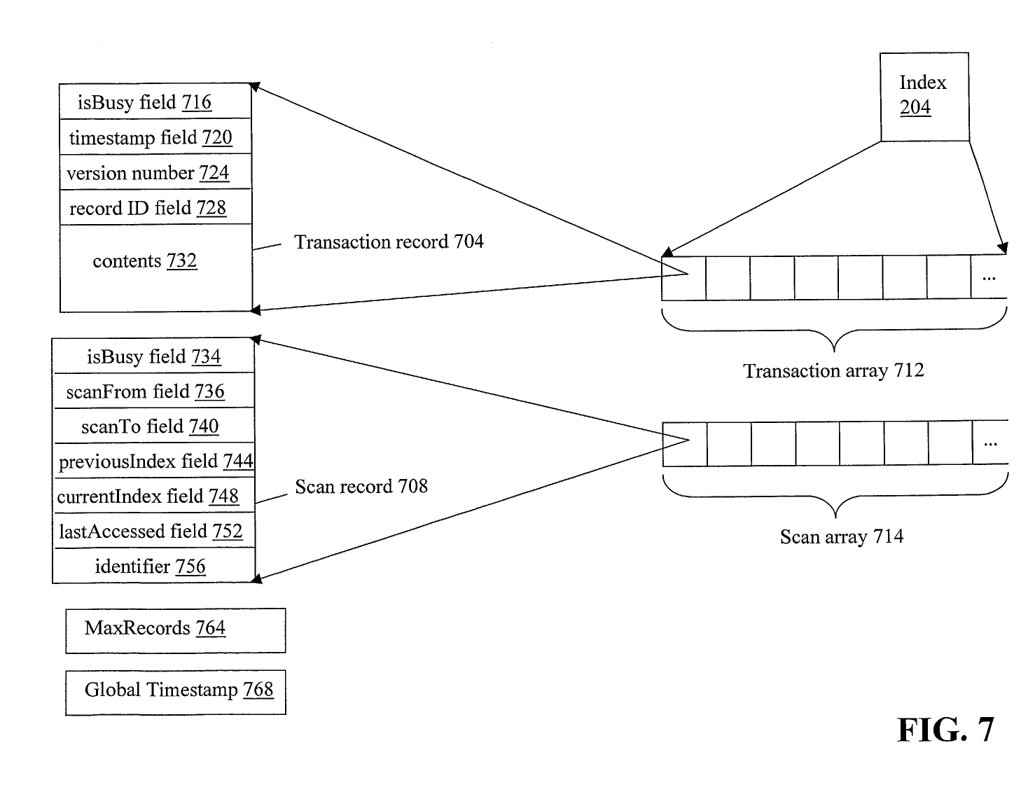

In more detail and referring to FIG. 7, in one embodiment the SSM 28 manages the scan session with a transaction record 704, a scan record 708, a transaction array 712, and a scan array 714. The transaction array 712 is an array of transaction records 704. Each transaction record 704 includes an isBusy field 716, a timestamp field 720, a version number 724, a transaction record ID field 728, and contents 732 of the transaction record 704.

The isBusy field 716 is a parameter that specifies whether the transaction record 704 is available (e.g., available, busy). In one embodiment, the isBusy field 716 is a boolean data type. In this embodiment, the isBusy field 716 equals False to denote the availability of the transaction record 704. In another embodiment, the isBusy field 716 is a string. In this embodiment, the isBusy field 716 can equal, for example, “Busy” to denote the non-availability of the transaction record 704.

If the SSM 28 receives an application request 236 (associated with a user request that the client 6 transmits to the server 4) to modify (i.e., update, delete) session information (i.e., contents 732 of a particular transaction record 704) and if the transaction record 704 is part of a scan session, the SSM 28 transforms the transaction record 704 into a version for use by the scan module 612. This enables the SSM 28 to transmit the version to the scan module 612 before the SSM 28 updates the session information. Thus, the scan module 612 receives the transaction record 704 in the same condition as the transaction record 704 was when the scan module 612 began the scan session. The version number 724 denotes the version of the transaction record 704 of session information. In one embodiment and as described hereinafter, the version number 724 is an array of a predetermined number of bits (e.g., thirty-two bits).

The transaction record ID field 728 is a unique identifier of transaction records 704 having their version number 724 set to zero. Further and as described hereinafter, the contents 732 of the transaction record 704 are the session information. Alternatively, the contents 732 of the transaction record 704 can be any data.

The scan array 714 is an array of scan records 708, which are records associated with a scan session. Each scan record 708 includes an isBusy field 734, a scanFrom field 736, a scanTo field 740, a previousIndex field 744, a currentIndex field 748, a lastAccessed field 752, and a scan request identifier 756.

During a scan session, the SSM 28 determines whether to transmit a particular transaction record 704 to the scan module 612 based on whether the transaction record 704 exhibits a predetermined characteristic. In a particular embodiment, the SSM 28 uses the scanFrom field 736 and the scanTo field 740 to make this determination. The scanFrom field 736 and the scanTo field 740 are two parameters that specify the range of the transaction records 704 that the scan module 612 requests. In one embodiment, the SSM 28 compares the scanFrom field 736 and the scanTo field 740 with the timestamp 720 of each transaction record 704 to determine whether the SSM 28 includes the particular transaction record 704 in the scan session (i.e., whether the SSM 28 transmits that particular record 704 to the scan module 612). Moreover, the transaction record 704 has to be located in the transaction array 712 after the current position of the scan session.

For example, if a previous scan returned all transaction records 704 having a timestamp 720 earlier than a given time, then a subsequent scan can scan all transaction records 704 that were created or updated after this time. This can reduce the cost associated with the performance of the scan module 612 (e.g., time needed to complete a scan session) because of the reduction in the number of transaction records 704 that the scan module 612 scans for a particular scan session.

The isBusy field 734 of the scan record 708 specifies whether the scan module 612 is busy for that scan session. The previousIndex field 744 is a pointer that references the transaction record 704 previously returned to the scan module 612. The currentIndex field 748 is a pointer that references the transaction record 704 that the SSM 28 is returning to the scan module 612 during the current scan session. The lastAccessed field 752 stores the last time the scan module 612 accessed the transaction record 704 and the SSM 28 uses the lastAccessed field 752 to remove the oldest scan records 708 when no more scan records 708 are available (i.e., the lastAccessed field 752 facilitates “garbage collection” of scan records 708). The scan request identifier 756 stores the most recently received (from the scan module 612) record retrieve request identifier (e.g., found in the most recently received record retrieve request 616).

The SSM 28 stores all transaction records 704, the transaction array 712, all scan records 708, and the scan array 714 in a transactional way by logging all updates in the log file 228, 232 prior to updating the database cache 216. This guarantees that the updates survive a server failure. Alternatively, the SSM 28 stores these records 704, 712 and these arrays 708, 714 in the persistent mass storage 22, such as a floppy disk, to survive a server failure.

The SSM 28 also includes a MaxRecords parameter 764 and a global timestamp 768. The MaxRecords parameter 764 denotes one more than the maximum number of transaction records 704 available for use. More specifically, the MaxRecords parameter 764 denotes one more than the last record indexed in the transaction array 712.

The timestamp 720 receives the value of the global timestamp 768 each time the corresponding record 704 is updated or created. Thus, later update modifications to the transaction record 704 have numbers greater than earlier updates, allowing the updates to be well-ordered. In one embodiment, the global timestamp 768 is a software-based counter that the SSM 28 increments in response to a start scan operation, an update, a creation, and/or a deletion of a transaction record 704. If the global timestamp 768 is a counter, the SSM 28 makes the counter persistent (e.g., by storing the counter in the persistent volatile memory 36 or a persistent memory, such as a disk). Alternatively, the SSM 28 reads a clock of the server 4 to generate a value for the timestamp 720.

In one embodiment, the SSM 28 initializes the global timestamp 768 to zero and uses the global timestamp 768 as the current time value to determine whether to include a particular transaction record 704 in the scan session.

The SSM 28 also uses the index 204 described above to provide an index to the transaction records 704 stored in the database cache 216. In one embodiment, the index 204 is based on the transaction record ID field 728. The SSM 28 maintains the index 204 for efficient retrieval of transaction records 704 (having their version equal to zero). The SSM 28 does not store updates to the index 204 in the persistent volatile memory 36 because the SSM 28 can recreate the index 204 from the transaction array 712 following a server failure.

Although the transaction and scan records 704, 708 are described as records and the transaction and scan arrays 712, 714 are described as arrays, the records 704, 708 and the arrays 712, 714 can be any data structure (e.g., list, linked list, array, record). Similarly, any of the above mentioned fields and/or parameters (e.g., previousIndex field 744, MaxRecords parameter 764) can be any size that can provide the required storage for the particular function. In particular and for example, the previousIndex 744 can be a byte, an octet, a word, or a long word, as long as the previousIndex 744 can point to the previous scan position (i.e., the previous transaction record 704 previously returned to the scan module 612).

The SSM 28 receives an application request 236 to modify a record of session information (i.e., the contents 732 of a transaction record 704). In one embodiment, the modification can be an update to session information. For example, a user of the client 6 may want to add an additional item into a virtual shopping cart, which requires updating the session information associated with that user. In another embodiment, the modification can be a deletion of session information. For instance, an application 18 may delete a record of session information if the application 18 determines that the particular session information no longer has a value (e.g., when the server 4 no longer needs the session information because the communication session has ended).

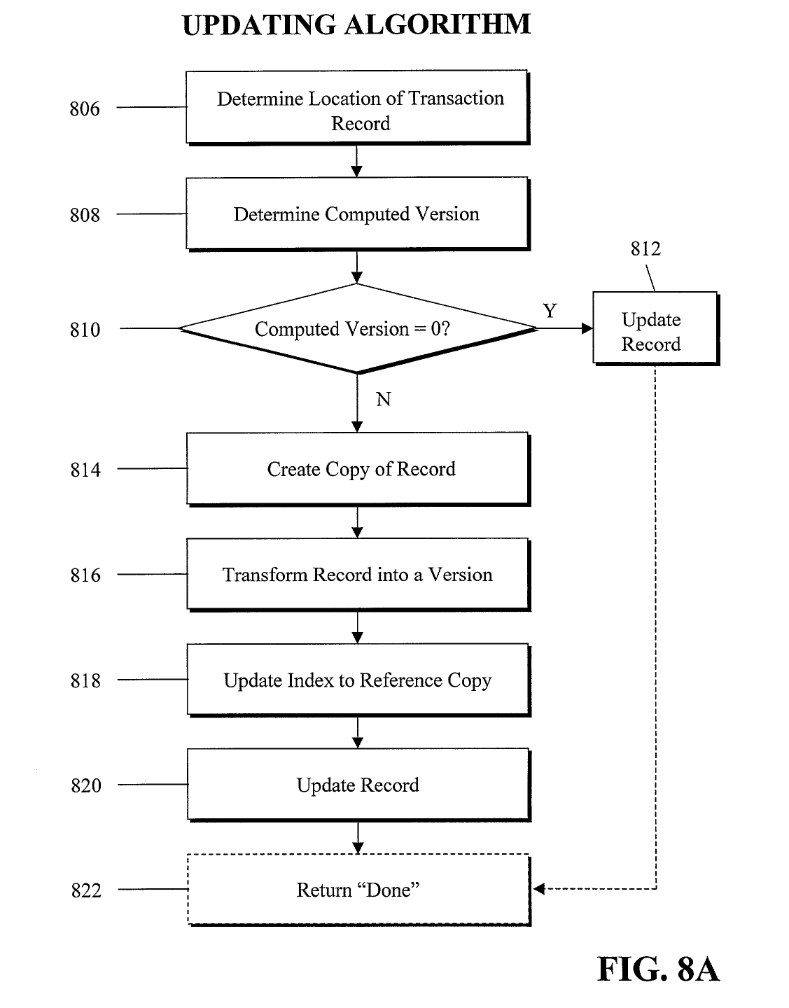

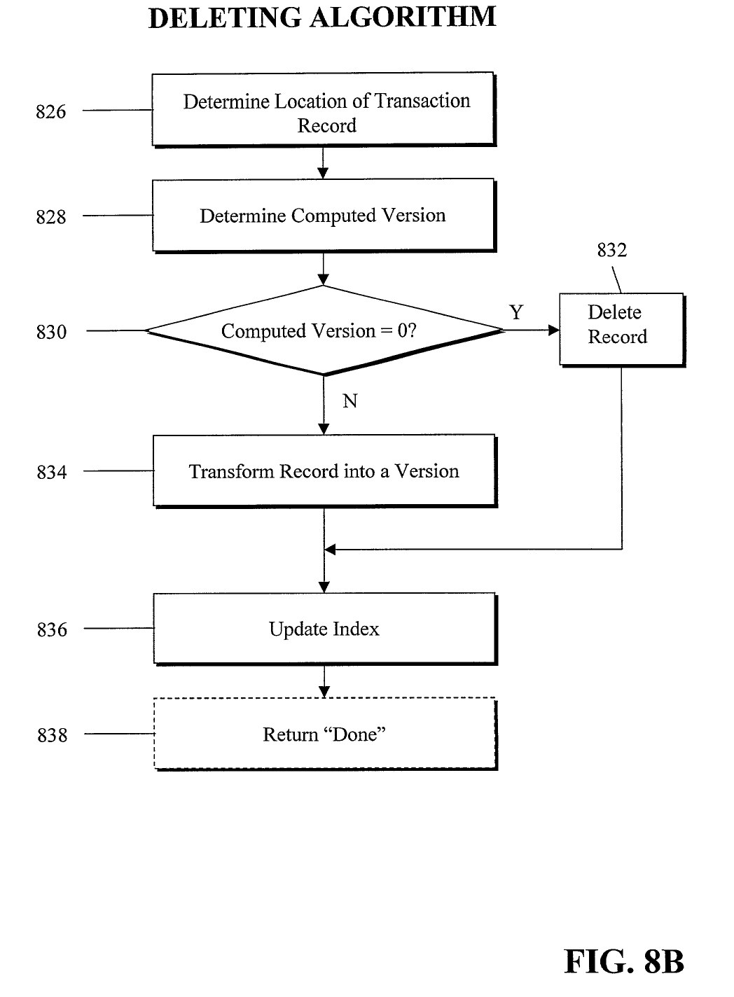

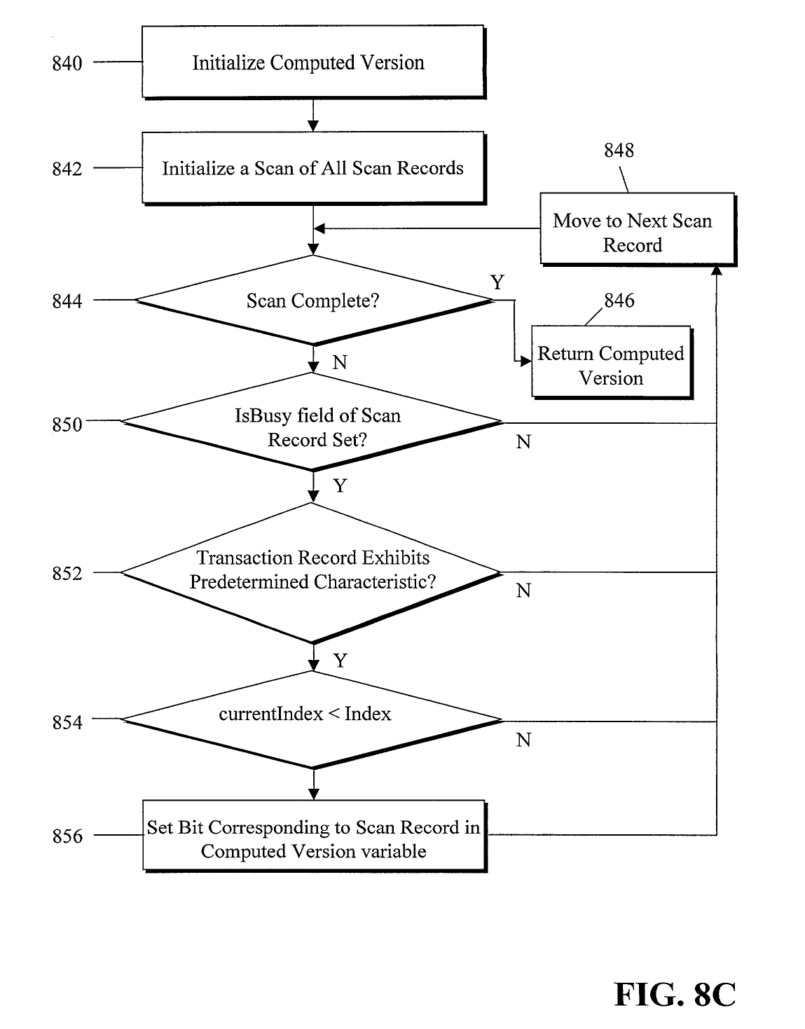

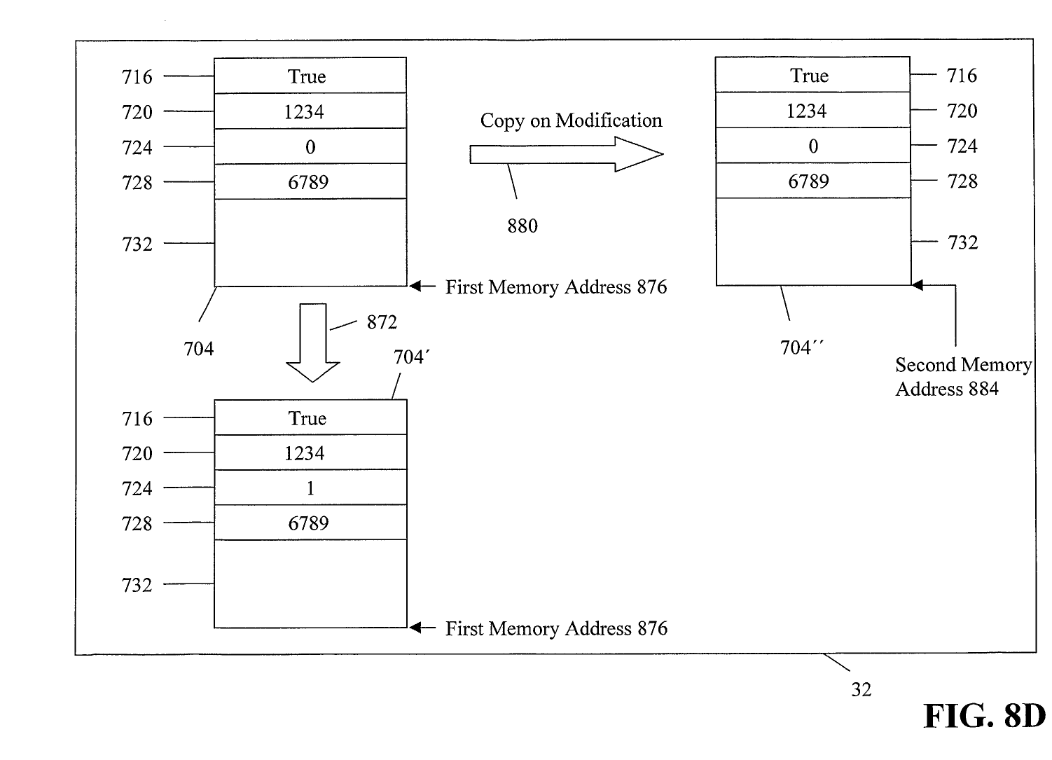

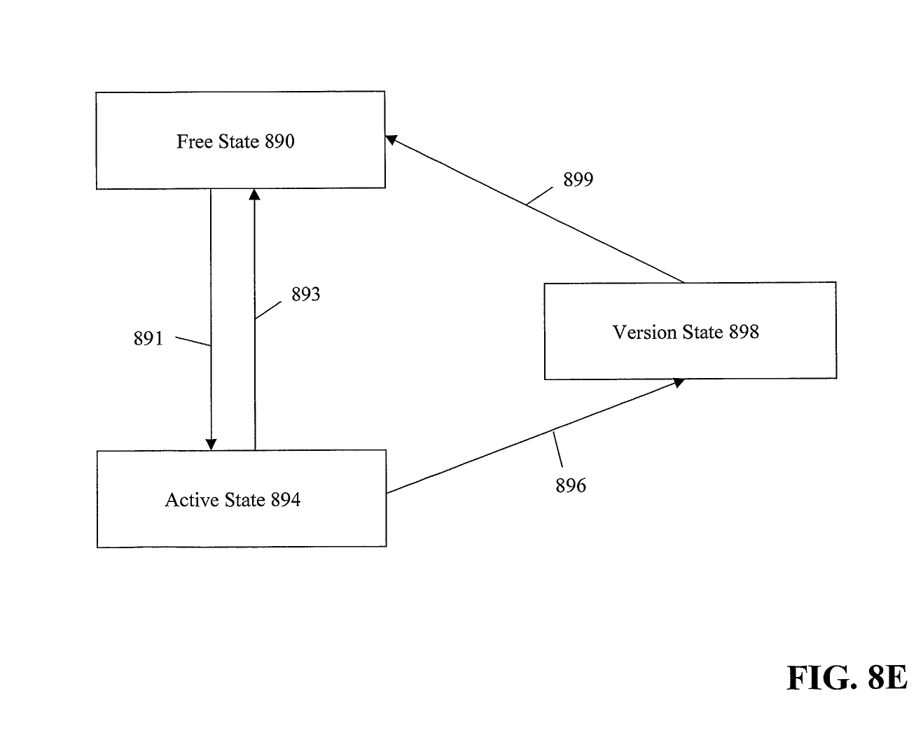

An embodiment of an updating algorithm executed by the SSM 28 when receiving an application request 236 to update session information stored in a transaction record 704 is illustrated in FIG. 8A. The SSM 28 receives the application request 236 to update particular session information and executes the updating algorithm. The updating algorithm determines (step 806) the location of the transaction record 704 to update from the index 204. Based on all active scan records 708, or all scan records 708 that have the isBusy field 734 set to True, the algorithm then determines (step 808) a ComputedVersion variable. The ComputedVersion variable has the same data type as the version number 724 and, in one embodiment, the ComputedVersion is an array of a predetermined number of bits (e.g., thirty-two bits). Each bit of the ComputedVersion represents a scan session. One embodiment of the determination of the ComputedVersion is described further in FIG. 8C. If the algorithm determines (step 810) that the ComputedVersion is equal to zero, the algorithm updates (step 812) the transaction record 704 with the updates requested in the application request 216. In one embodiment, the updating algorithm then denotes the completion of the update(s) by transmitting (step 822) a “done” command to the SSM 28. Alternatively, the updating algorithm does not transmit any message back to the SSM 28 unless an error occurred and the update(s) were not completed. In yet another embodiment, the updating algorithm transmits an error message to the SSM 28 when one or more errors occur in the attempted updates.

If the updating algorithm determines (step 810) that the ComputedVersion is not equal to zero, then the updating algorithm creates (step 814) a copy of the transaction record 704, as described further below in FIG. 8D. The updating algorithm then transforms (step 816) the transaction record 704 into a version by updating the version number 724 of the transaction record 704 with the ComputedVersion. The updating algorithm then updates (step 818) the index 204 to reference the copy of the transaction record 704 rather than the copied transaction record 704 so that the index 204 will reference the transaction record 704 (i.e., the copy) having the most up-to-date information. The updating algorithm then updates (step 820) the copy with the updates requested in the application request 236 and can denote its completion of the update by transmitting (step 822) a “done” command to the SSM 28.

An embodiment of a deleting algorithm executed by the SSM 28 when receiving an application request 236 to delete session information stored in a transaction record 704 is illustrated in FIG. 8B and is similar to the steps performed by the updating algorithm. The SSM 28 receives the application request 236 to delete particular session information and invokes the deleting algorithm. The deleting algorithm determines (step 826) the location of the transaction record 704 to delete from the index 204. Based on all active scan records 708, or all scan records 708 that have the isBusy field 734 set to True, the deleting algorithm then determines (step 828) the ComputedVersion of the transaction record 704. If the deleting algorithm determines (step 830) that the ComputedVersion is equal to zero, the deleting algorithm (SSM 28) deletes (step 832) the transaction record 704 by setting the isBusy field 716 of the transaction record 704 to False. The deleting algorithm then updates (step 836) the index 204 to delete the reference to the deleted transaction record 704.

If the deleting algorithm determines (step 830) that the ComputedVersion is not equal to zero, then the deleting algorithm transforms (step 834) the transaction record 704 into a version by updating the version number 724 of the transaction record 704 with the ComputedVersion before updating the index 204 in step 836. The deleting algorithm then denotes its completion of the deletion by transmitting (step 838) a “done” command to the SSM 28.

Referring now to FIG. 8C, more detail about one embodiment of a method to determine a ComputedVersion (step 808 and step 828 in FIG. 8A) is shown. The SSM 28 initializes (step 840) a ComputedVersion variable to a predetermined value, such as zero. The SSM 28 then initializes (step 842) a scan of all of the scan records 708 to determine if the contents 732 of a transaction record 704 should be transmitted to the scan module 612 (i.e., part of a scan session) before the SSM 28 performs the modification (e.g., update). The SSM 28 then determines (step 844) if there are more scan records 708 that have not yet been looked at by the SSM 28. If the SSM 28 has viewed every scan record 708, then the ComputedVersion variable is returned (step 846) to the SSM 28.

If the SSM 28 has not viewed every scan record 708, then the SSM 28 checks (step 850) the isBusy field 734 of the scan record 708 to determine if that scan record 708 is available. If the isBusy field 734 is not set (e.g., set to False), the SSM 28 continues the scan session by moving (step 848) to the next scan record 708. The SSM 28 then determines if the scan session is complete and, if so, returns (step 846) the ComputedVersion to the SSM 28.

If the isBusy field 734 is set (e.g., True), the SSM 28 then determines (step 852) if the transaction record 704 to be updated or deleted exhibits the predetermined characteristic for the current scan session. In one embodiment, the SSM 28 determines if the scanFrom field 736 and the scanTo field 740 of the current scan record 708 are between the timestamp field 720. If not, the SSM 28 continues (step 848) with the next scan record 708.

If the transaction record 704 exhibits the predetermined characteristic, the SSM 28 then determines (step 854) if the currentIndex field 748 is less than the index 204 associated with the transaction record 704 to be updated or deleted. If so, then the algorithm sets (step 856) the bit of the ComputedVersion variable corresponding to the scan record 708 and moves on to the next scan record 708 if there are additional scan records 708 in the scan session.

Thus, the SSM 28 sets a bit in the ComputedVersion variable corresponding to the contents 732 of a transaction record 704 that have to be transmitted to the scan module 612 before the SSM 28 performs the modification. When the SSM 28 has checked all of the scan records 708, if every bit of the ComputedVersion is equal to zero, then the transaction record 704 (i.e., the contents 732) can be modified without the creation of a version. Otherwise, the SSM 28 has to generate a version before performing the modification. In one embodiment, the SSM 28 subsequently copies the ComputedVersion into the version number 724 of the transaction record 704.

Referring now to FIG. 8D, more detail about one embodiment of the creation of a version and a copy of the transaction record 704 (steps 814, 816 and 834) is shown. To avoid blocking user requests to update or delete session information used during a scan session, the SSM 28 transforms the original transaction record 704 (shown with sample values such as setting the isBusy field 716 to True) into a version 704′ for use by the scan module 612 before the SSM 28 modifies (i.e., updates, deletes) the contents 732 of the transaction record 704. This enables the SSM 28 to transmit a transaction record 704 (i.e., a version 704′ of the original transaction record 704) having the same contents 732 as when the scan module 612 started the scan session. Additionally, the SSM 28 does not update a version 704′ once it is created. Instead, the SSM 28 creates a new version 704′ when needed for additional scan sessions.

More specifically, the SSM 28 creates a version 704′ of the transaction record 704 for each scan session before the SSM 28 has to transmit that transaction record 704 to the scan module 612. In one embodiment, the SSM 28 reads the currentIndex field 748 of the scan record 708 to determine the position in the transaction array 712 of the transaction record 704 that the SSM 28 will transmit to the scan module 612. The transformation of the transaction record 704 into a version 704′, as shown by arrow 872, involves setting a particular bit in the version number 724 associated with that particular scan session (as the version number 724 is an array of bits representing the total number of versions 704′ created for that transaction record 704).

The SSM 28 stores the transaction record 704 in the volatile memory 32 at a particular first memory address 876. The SSM 28 also stores the transaction record 704 in the persistent volatile memory 36. Because the SSM 28 creates the version transaction record 704′ by altering the fields (e.g., version number 720) of the transaction record 704, the version 704′ occupies the same location in the volatile memory 32 (and the persistent volatile memory 36) as the original transaction record 704 had (e.g., the first memory address 876) in each memory 32, 36.

In more detail about the state transitions of a transaction record 704 and also referring to FIG. 8E, a transaction record 704 can transition between three states: a free, or unallocated, state 890, an active state 894, and a version state 898. The isBusy field 716 of the transaction record 704 is typically initialized to False, thus denoting the free state 890 of the transaction record 704. If the client 6 transmits a user request causing the SSM 28 to create a new transaction record 704 of session information, the SSM 28 uses a transaction record 704 in the free state 890 for the new session information and therefore transitions the transaction record 704 to the active state 894 (e.g., set the isBusy field 716 of the transaction record 704 to True). The arrow 891 represents this transition of a transaction record 704 from the free state 890 to the active state 894 due to the creation of a new transaction record 704.

Similarly, if the SSM 28 receives an application request 236 to update the session information contained in a transaction record 704 (as described above in FIG. 8A), the SSM 28 checks whether the transaction record 704 exhibits the predetermined characteristic (e.g., the transaction record 704 has a timestamp field 720 within the scan range of a requested scan session and is located after the currentIndex field 748 of the scan record 708). If not, the SSM 28 maintains the active state of the transaction record 704 and creates the update copy 704″.

If the SSM 28 deletes a transaction record 704 that does not exhibit the predetermined characteristic, the state of the transaction record 704 transitions from the active state 894 back to the free state 890. In one embodiment, this transition occurs when the SSM 28 sets the isBusy field 716 of the transaction record 704 back to False.

If, however, the SSM 28 needs to create a version 704′ of the transaction record 704, the transaction record 704 transitions from the active state 794 to the version state 898. The transition is shown with arrow 896. When the scan module 612 has viewed the version 704′ for every scan session associated with that version 704′ (e.g., the version number 724 of the version 704′ is equal to zero), the SSM 28 removes the version 704′ (i.e., the version 704′ is “garbage collected”) and the state of the version 704′ transitions from the version state 898 to the free state 890. This transition is denoted by arrow 899.

Additionally, a full scan of a database can be a time-consuming task. This time is typically increased further when a process or device requests one or more additional scans of a database that has previously been scanned, as the records read for the previous scan are typically read again for the newly requested scan. To prevent the repetitious reading of the same records and to consequently decrease the time spent in a re-scan operation, the scan module 612 only scans the records updated since the last scan performed on that particular database.

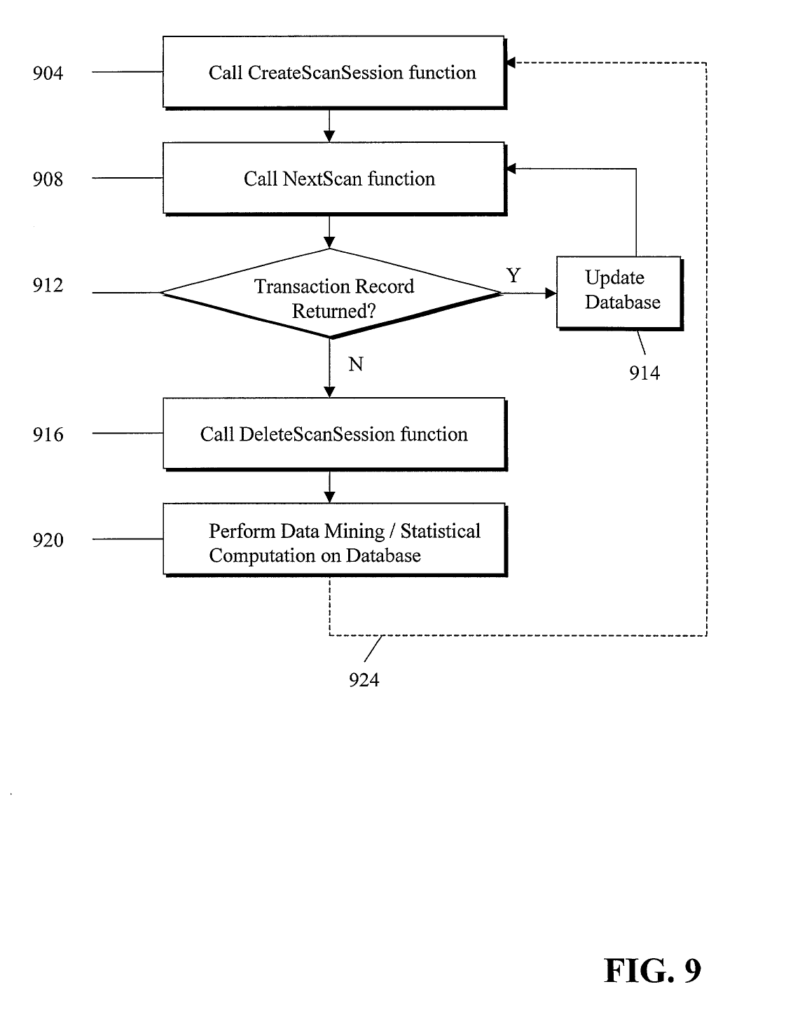

An embodiment of the steps that the scan module 12 performs to re-scan a database is illustrated in FIG. 9. The start scan request 616 calls (step 904) a CreateScanSession function to initiate a new scan operation. The function searches for an available scan record 708 in the scan array 714 for the data associated with the new scan. If the function locates an available scan record 708, the function initializes the record fields 734, 736, 740, 744, 748, 752, 756 of the scan record 708 and returns the value of the global timestamp 768 (i.e., the current time). For example, the function initializes the isBusy field 734 to True and initializes the scanFrom field 736 to the first transaction record 704 of the transaction array 712. Moreover, the scanTo field 740 is initialized to the current value of the global timestamp 768. In a further embodiment, the function returns a value denoting an error if the function is not able to locate an available scan record 708. In one embodiment, the scan module 612 calls the CreateScanSession function with the start scan request 616.

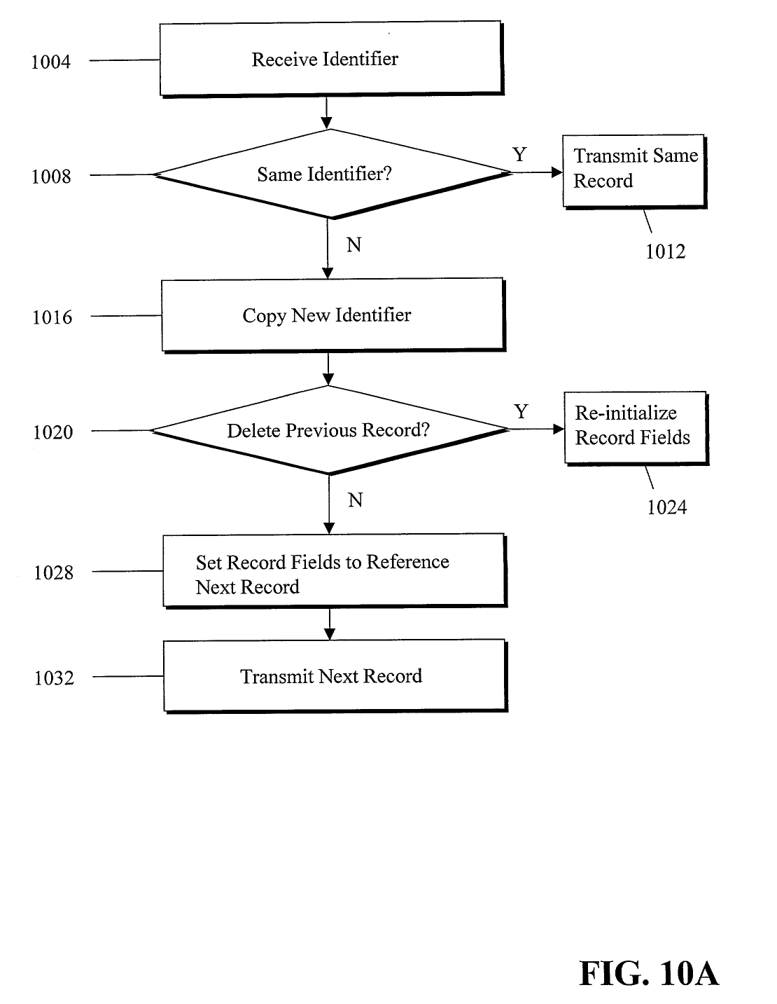

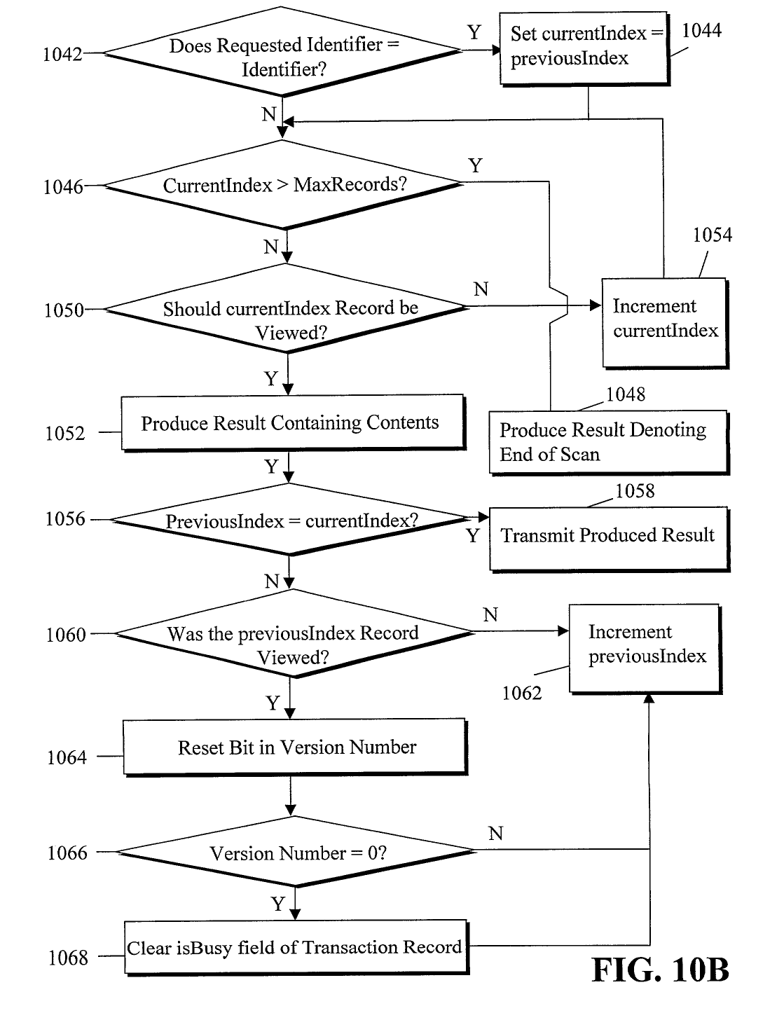

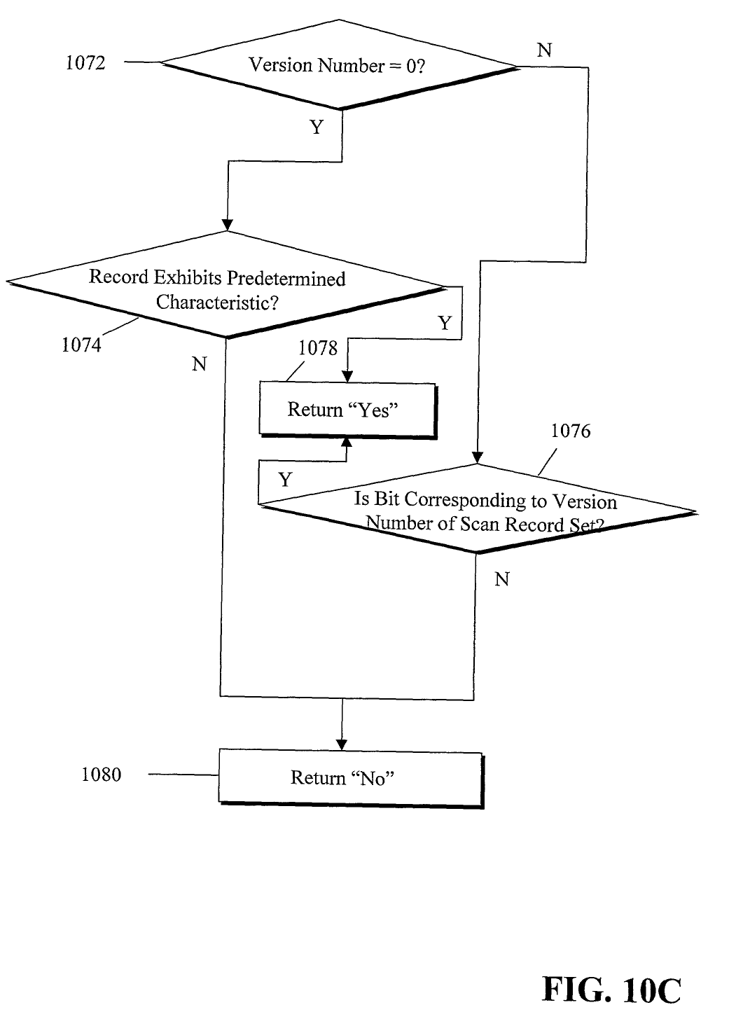

In one embodiment, the scan module 612 then calls (step 908) a NextScan function, which is described in more detail with respect to FIGS. 10A-10C. In general, the NextScan function returns the contents 732 of the next transaction record 704 and the transaction record ID field 728 associated with the returned contents 732 of the transaction record 704. Although described as returning contents 732 of a particular transaction record 704, the NextScan function can also return contents 732 of a group of transaction records 704. This may be advantageous because it can reduce the number of transmissions of scanning information between the scan module 612 and the SSM 28. Moreover, it may also reduce the number of transmissions of scanning information across the network 7 between the client 6 and the server 4. In one embodiment, the scan module 612 calls the NextScan function with a record retrieve request 616.

If the scan module 612 had previously invoked the CreateScanSession function, the NextScan function returns the contents 732 of the first transaction record 704. Otherwise, the NextScan function returns the contents 732 of the next transaction record 704 having a predetermined characteristic, such as having a timestamp field 720 between the scanFrom field 736 and the scanTo field 740. The NextScan function also returns the transaction record ID field 728 associated with the transaction record 704 to facilitate identification of the transaction record 704.

The scan module 612 then determines in step 912 whether the NextScan function returned a transaction record 704. In other words, the scan module 612 determines whether the scan of the transaction records 704 reached the last transaction record 704 of the scan.

For example, if the scan module 612 invokes a first scan of the transaction array 712 from a time T₁ to a time T₂, the scan module 612 stores the records 704 created or updated between time T₁ and time T₂ in the database 622 for subsequent data mining by the data mining and statistical analysis tool 624. If the SSM 28 receives an application request 226 to update the contents 732 of a transaction record 704, the SSM 28 creates a version 704′ and an update copy 704″. The SSM 28 then returns to the scan module 612 the version 704′ having the contents 732 that the transaction record 704 had when the scan module 612 started the scan session. The SSM 28 then updates the contents 732 of the update copy 704″. This update would not be returned to the scan module 612 during this scan session because each scan session occurs in isolation so that the returned transaction records 704 have the same information (e.g., timestamp 720, contents 732) as when the scan module 612 started the scan session.

If the NextScan function returns a transaction record 704, then the scan module 612 updates (step 914) the database 622 with the particular transaction record 704. In one embodiment, the transaction record 704 returned by the SSM 28 contains updated contents 732 (i.e., updated session information). Alternatively, the transaction record 704 returned by the SSM 28 contains new contents 732 (i.e., new session information). If the transaction record 704 contains new session information, then the scan module 612 inserts the transaction record 704 into the database 622. If the transaction record 704 contains updated session information, then the scan module 612 updates the transaction record 704 already stored in the database 622.

If the NextScan function does not return a transaction record 704 (i.e., finished the scan session), then the scan module 612 then invokes (step 916) a DeleteScanSession function. In response to this function call, the SSM 28 uses the previousIndex field 744 to iterate through all transaction records 704 in the transaction array 712 between the value of the previousIndex field 744 and one less than the currentIndex field 748 to delete useless versions 704′.

In a further embodiment, the SSM 28 determines whether the contents 732 of a transaction record 704 should be deleted because the transaction record 704 has not been accessed in a predetermined amount of time. For example, if the scan module 612 experiences a failure (e.g., a halt), the SSM 28 may execute the DeleteScanSession itself to delete the useless versions 704′.

Once the database 622 contains the updated records 704 of session information and the scan session is complete, the data mining and statistical tool 624 mines (step 920) the session information stored in the database 622.

The scan module 612 then invokes (step 924) another scan session when the data mining and statistical tool 624 requires additional mining and/or statistical computation on one or more new transaction record(s) 704. In one embodiment, the scan module 612 sets the scanFrom field 736 equal to the scanTo field 740 for a new scan session so that the range of transaction records 704 that the SSM 28 returns to the scan module 612 begins where the scan module 612 ended the last scan session. In other embodiments, the scan module 612 sets the scanFrom field 736 to a different value to request a range of transaction records 704 located at some other location in the transaction array 712.

FIG. 10A shows a more-detailed flow chart of the steps performed by the NextScan function. The scan module 612 transmits a record retrieve request 616 to the SSM 28 for the next transaction record 704 in the transaction array 712. If the NextScan function did not use a new scan request identifier 756, the SSM 28 may not return all of the transaction records 704 having the predetermined characteristic (e.g., within the particular time frame). For instance, the NextScan function may receive a duplicate request for a transaction record 704 when the server 4 (and therefore the SSM 28) experiences a failure. In one embodiment, the SSM 28 does not receive a transmitted record retrieve request 616 from the scan module 612 and accordingly does not return a transaction record 704. Accordingly, the SSM 28 does not change the state of any record fields (e.g., the currentIndex 748). In another embodiment, the SSM 28 was processing the record retrieve request 616 before the server 4 experienced a failure. In this example, the SSM 28 will erase the incomplete updates done in response to the record retrieve request 616 and, consequently, the SSM 28 again does not return a transaction record 704. Accordingly, the SSM 28 also again does not change the state of any record fields (e.g., the currentIndex 748). In yet another embodiment, the SSM 28 experiences a failure after completing the processing associated with the record retrieve request 616 but the SSM 28 did not transmit the result of the processing (i.e., the transaction record 704) to the scan module 612. Alternatively, the communication channel (e.g., network connection) between the scan module 612 and the SSM 28 could experience a failure and result in one or more of the above scenarios.

To solve these problems, each record retrieve request 616 following the start scan request 616 includes a record retrieve request identifier. In particular, the NextScan function receives the record retrieve request identifier (step 1004) and then checks (step 1008) whether the received record retrieve request identifier is the same as the identifier 756 stored in the scan record 708. Because the SSM 28 stores the transaction array 712 (as well as the transaction records 704) and the scan array 714 (as well as the scan records 708) in a persistent memory (e.g., the persistent volatile memory 36, disk), the SSM 28 can perform this check following a server failure. If the two identifiers (i.e., the record retrieve request identifier and the identifier 756) are the same, then the NextScan function was not able to transmit the previously requested transaction record 704 to the scan module 612 (e.g., because of a server failure). More specifically, the scan module 612 never received the transaction record 704 and therefore never generated a new scan request identifier 756. Consequently, upon the receipt of the same scan request identifier 756, the SSM 28 transmits (step 1012) the same transaction record 704 as previously requested.

If the currently received scan request identifier 756 is not equivalent to the scan request identifier 756 stored in the scan record 708, the NextScan function copies (step 1016) the currently received scan request identifier 756 to the scan record 708 (which the SSM 28 eventually logs and stores in the persistent volatile memory 36).

The NextScan function then determines (step 1020) whether the transaction record 704 lastly transmitted to the scan module 612 is a version that can be deleted. In one embodiment, the NextScan function accesses the transaction record 704 previously transmitted and, if the version number 724 is larger than zero, clears the bit associated with the version 704′ in the version number 724 associated with that scan session. If the version number 724 then equals zero (after clearing the associated bit), then the scan module 612 is not using a version 704′ of the particular transaction record 704 for any other scan session and therefore the SSM 28 deletes the version 704′.

The NextScan function then sets (step 1028) the record fields (e.g., currentIndex 748) to reference the next transaction record 704 in the transaction array 712 for the current NextScan function call. In particular, the purpose of the NextScan function call is to return the next transaction record 704 in the transaction array 712. Thus, the setting of the record fields in step 1028 to reference the next transaction record 704 is an increment of the index of the transaction array 712 to return the first transaction record 704 in the transaction array 712 that the NextScan function has not returned to the scan module 712. Moreover, the NextScan function does not return transaction records 704 that are unallocated (i.e., isBusy=False) or transaction records 704 that do not exhibit the predetermined characteristic (e.g., are not between two times, such as T₁ and T₂ or are not located after the currentIndex field 748 in the transaction array 712). Further, the NextScan function does not return transaction records 704 that are located outside of the MaxRecords parameter 764. The NextScan function then transmits (step 1032) the transaction record ID field 728 and the contents 732 of the referenced transaction record 704 (e.g., the session information) to the scan module 612. 10152

In even more detail about the NextScan operation, and referring to FIG. 10B, the SSM 28 receives a NextScan request from the scan module 612 and the SSM 28 checks (step 1042) whether the record retrieve request identifier is equal to the identifier 756 of the scan record 708. As described above, if the two identifiers are equivalent, then the scan module 612 never received the previously requested transaction record 704 and therefore never generated a new scan request identifier 756. The SSM 28 consequently sets (step 1044) the currentIndex field 748 of the scan record 708 to the previousIndex field 744 to reference the previously requested transaction record 704.

The SSM 28 then determines if the transaction record 704 currently referenced by the currentIndex field 748 is a record outside of the range of available transaction records 704 by comparing (step 1046) the currentIndex field 748 to the MaxRecords parameter 764. If the currentIndex field 748 is greater than the MaxRecords parameter 764, the SSM 28 produces (step 1048) a result denoting the end of the scan information.

If the currentIndex field 748 is less than the MaxRecords parameter 764, the SSM 28 then determines (step 1050) if the transaction record 704 referenced by the currentIndex field 748 should be transmitted to the scan module 612 (i.e., whether the transaction record 704 is part of the scan session). If the SSM 28 determines, as described in more detail in FIG. 10C, that the transaction record 704 referenced by the currentIndex field 748 is not a record 704 to be transmitted to the scan module 612, the SSM 28 increments (step 1054) the currentIndex field 748 to point to the next transaction record 704 in the transaction array 712. Once this occurs, the SSM 28 repeats the process beginning at step 1046.

If the SSM 28 determines that the transaction record 704 should be part of the records 704 requested by the scan module 612, the SSM 28 produces (step 1052) a result containing the contents 732 and the record ID field 728 of the transaction record 704 referenced by the currentIndex field 748. Thus, the SSM 28 transmits a portion of the transaction record 704 to the scan module 612, as the scan module 612 does not employ many of the other fields (e.g., version number 728).

The SSM 28 then compares (step 1056) the previousIndex field 744 with the currentIndex field 748. If the indexes 744, 748 are equivalent, the SSM 28 transmits (step 1058) the produced result to the scan module 612.

If the two indexes 744, 748 are not equal, the SSM 28 then determines (step 1060) whether the transaction record 704 referenced by the previousIndex field 744 was previously viewed by the scan module 612. If the SSM 28 determines that the transaction record 704 was viewed, then the SSM 28 increments (step 1062) the previousIndex field 744 to point to the next transaction record 704 in the transaction array 712.

If the SSM 28 determines (step 1060) that the transaction record 704 referenced by the previousIndex field 744 was not viewed by the scan module 612 as part of the current scan session, the SSM 28 then resets (step 1064) the bit of the version number 724 of the transaction record 704 referenced by the previousIndex field 744 and corresponding to the current scan record 708. The SSM 28 then determines (step 1066) whether the version number 724 of the transaction record 704 referenced by the previousIndex 744 is equal to zero. If not, the SSM 28 then increments (step 1062) the previousIndex field 744. If the version number 724 of the transaction record 704 referenced by the previousIndex 744 is equal to zero, the SSM 28 then clears (step 1068) the isBusy field 716 of the transaction record 704 referenced by the currentIndex field 748 (i.e., the SSM 28 sets the isBusy field 716 to False) and the transaction record 704 is “garbage collected”. The SSM 28 then returns to step 1062 to increment the previousIndex field 744.

FIG. 10C illustrates a more detail flow chart describing the steps performed by the SSM 28 to determine whether the transaction record 704 referenced by the previousIndex field 744 or the currentIndex field 748 was/should be viewed by the scan module 612 during a scan session (steps 1050 and 1060 in FIG. 10B). The SSM 28 checks (step 1072) whether the version number 724 of the transaction record 704 indexed by the currentIndex field 748/previousIndex record 744 is equal to zero. More explicitly, the SSM 28 determines if the version number 724 of the transaction record 704 indexed by the currentIndex field 748 is equal to zero when performing this operation in response to step 1050. The SSM 28 determines if the version number 724 of the transaction record 704 indexed by the previousIndex field 744 is equal to zero when performing this operation in response to step 1060.

If the version number 724 is equal to zero, the SSM 28 determines (step 1074) whether the particular transaction record 704 (indexed by the corresponding index field 744, 748) exhibits the predetermined characteristics. If the record 704 does, then the SSM 28 returns (step 1078) a “Yes” to the appropriate calling function (step 1050 or 1060). If the transaction record 704 does not exhibit the predetermined characteristic, and thus is not part of the scan session, the SSM 28 returns (step 1080) a “No” to the calling function (step 1050 or 1060).

If the SSM 28 determines in step 1072 that the version number 724 of the indexed transaction record 704 (i.e., transaction record 704 indexed by the previousIndex field 744, transaction record 704 indexed by the currentIndex field 748) does not equal zero, the SSM 28 then checks (step 1076) whether the bit in the version number 724 corresponding to the scan record 708 (i.e., corresponding to the scan session) is set. If so, then the SSM 28 returns “Yes” to the calling function in step 1078. If not, the SSM 28 returns “No” to the calling function in step 1080.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method for managing one or more records comprising:
(a) receiving a scan request identifying a record exhibiting a predetermined characteristic;
(b) receiving an application request to modify the record; and
(c) transforming the requested record into a version.

2. The method of claim 1 further comprising storing the version in persistent memory.

3. The method of claim 2 further comprising storing the version in a persistent volatile memory.

4. The method of claim 1 wherein the scan request further comprises a first time and a second time.

5. The method of claim 4 wherein the predetermined characteristic is whether a timestamp associated with the record is between the first time and the second time.

6. The method of claim 1 further comprising using a pointer to point to a start address of the current requested record.

7. The method of claim 6 wherein the predetermined characteristic is whether the requested record is located at an address after the start address of the current requested record.

8. The method of claim 1 further comprising transmitting the version to a scan module.

9. The method of claim 1 further comprising receiving an additional scan request identifying a next record.

10. The method of claim 1 further comprising copying the record into an update copy if the application request is an update to the requested record and the record exhibits the predetermined characteristic.

11. The method of claim 10 further comprising performing the update on the update copy.

12. The method of claim 1 wherein the scan request further comprises an identifier.

13. The method of claim 12 wherein the identifier is a random number.

14. The method of claim 1 wherein the modification further comprises deleting the requested record.

15. The method of claim 14 further comprising determining whether a bit of a version number is equal to zero.

16. The method of claim 1 further comprising performing data mining and statistical analysis on a collection of records that includes the version.

17. A method for managing one or more records comprising:
(a) receiving a scan request identifying a record exhibiting a predetermined characteristic;
(b) receiving an application request to modify the record;
(c) transforming the requested record into a version; and
(d) storing the version in a persistent memory.

18. An apparatus for managing one or more records, the apparatus comprising:
(a) a scan module; and
(b) a session storage manager in communication with the scan module, the session storage manager receiving a scan request from the scan module identifying a record exhibiting a predetermined characteristic and receiving an application request to modify the record,
wherein the session storage manager transforms the requested record into a version and stores the version in a persistent volatile memory before performing the modification.

19. The apparatus of claim 18 further comprising a decision support system in communication with the scan module.

20. The apparatus of claim 19 further comprising a persistent mass storage to store the version of the requested record.

21. The apparatus of claim 18 wherein the scan request further comprises a first time and a second time.

22. The apparatus of claim 21 wherein the predetermined characteristic is whether a time stamp associated with the record is between the first time and the second time.

23. The apparatus of claim 18 wherein the scan request further comprises an identifier that identifies the requested record.

24. The apparatus of claim 23 further comprising an index for the records based on the identifier.

25. An apparatus for managing one or more records, the apparatus comprising:
(a) means for receiving a scan request identifying a record exhibiting a predetermined characteristic;
(b) means for receiving an application request to modify the record;
(c) means for transforming the requested record into a version; and
(d) means for storing the version in a persistent memory.

26. The apparatus of claim 25 wherein the means for storing the version in a persistent memory further comprises means for storing the version in a persistent volatile memory.
